(19) United States
(12) Patent Application Publication
(10) Pub. No.: US 2014/0289569 A1
(43) Pub. Date: Sep. 25, 2014

(54) SEMICONDUCTOR STORAGE DEVICE, CONTROLLER, AND MEMORY SYSTEM

(71) Applicant: Kabushiki Kaisha Toshiba, Minato-ku (JP)

(72) Inventors: Jota TACHIKAWA, Kanagawa-ken (JP); Yasuyuki Matsuda, Kanagawa-ken (JP)

(73) Assignee: Kabushiki Kaisha Toshiba, Minato-ku (JP)

(21) Appl. No.: 14/021,068

(22) Filed: Sep. 9, 2013

(30) Foreign Application Priority Data
Mar. 22, 2013 (JP) 2013-060654

(51) Int. Cl. G06F 11/07

(52) U.S. Cl. CPC G06F 11/073
USPC 714/42

(57) ABSTRACT

According to one embodiment, a semiconductor storage device includes a memory cell array, a plurality of first latch circuits, a first register and a comparator. The memory cell array has a plurality of memory cells associated with columns. The first latch circuits are provided corresponding to the respective columns, and each of the first latch circuits holds data on whether or not the corresponding column has a failure. The first register holds the number of columns for redundancy. The comparator compares the number of the first latch circuits holding the data that the corresponding columns have failures with a criterion based on the data held by the first register. The semiconductor storage device determines whether or not there is a failure in the first latch circuit, based on the result of the comparison by the comparator.

### CROSS REFERENCE TO RELATED APPLICATION

This application is based upon and claims the benefit of priority from the prior Japanese Patent Application No. 2013-060654, filed on Mar. 22, 2013, the entire contents of which are incorporated herein by reference.

### FIELD

Embodiments described herein relate to a semiconductor storage device, a controller, and a memory system.

### BACKGROUND

There has been known an NAND-type flash memory having three-dimensionally arranged memory cells.

### BRIEF DESCRIPTION OF THE DRAWINGS

FIG. 1 is a block diagram of a semiconductor storage device according to a first embodiment;

FIG. 2 is a circuit diagram showing a memory cell array according to the first embodiment;

FIG. 3 is a schematic diagram showing a one-page configuration according to the first embodiment;

FIG. 4 is a block diagram showing a column controller according to the first embodiment;

FIG. 5 is a flowchart showing a failure detection method according to the first embodiment;

FIG. 6 is a block diagram showing the column controller according to the first embodiment;

FIG. 7 is a block diagram showing the column controller according to the first embodiment;

FIG. 8 is a block diagram showing the column controller according to the first embodiment;

FIG. 9 is a block diagram showing the column controller according to the first embodiment;

FIG. 10 is a block diagram showing the column controller according to the first embodiment;

FIG. 11 is a block diagram showing the column controller according to the first embodiment;

FIG. 12 is a block diagram showing the column controller according to the first embodiment;

FIG. 13 is a block diagram showing the column controller according to the first embodiment;

FIG. 14 is a block diagram showing the column controller according to the first embodiment;

FIG. 15 is a block diagram showing the column controller according to the first embodiment;

FIG. 16 is a flowchart showing a failure detection method according to a second embodiment;

FIG. 17 is a block diagram showing operations of a column controller according to the second embodiment;

FIG. 18 is a block diagram showing operations of the column controller according to the second embodiment;

FIGS. 19(a) and 19(b) are block diagrams showing operations of a column controller according to a third embodiment;

FIG. 20 is a block diagram showing a comparator according to the third embodiment;

FIG. 21 is a block diagram showing a configuration of a latch circuit according to a fourth embodiment;

FIG. 22 is a flowchart showing a failure detection method according to the fourth embodiment;

FIG. 23 is a block diagram showing operations of a column controller according to the fourth embodiment;

FIG. 24 is a block diagram showing operations of the column controller according to the fourth embodiment;

FIG. 25 is a block diagram showing operations of the column controller according to the fourth embodiment;

FIG. 26 is a block diagram showing operations of the column controller according to the fourth embodiment;

FIG. 27 is a flowchart showing a failure detection method according to a fifth embodiment;

FIG. 28 is a block diagram showing operations of a column controller according to the fifth embodiment;

FIG. 29 is a flowchart showing a failure detection method according to a sixth embodiment;

FIG. 30 is a block diagram showing operations of a column controller according to the sixth embodiment;

FIG. 31 is a block diagram showing a memory system according to a seventh embodiment;

FIG. 32 is a flowchart showing operations of a semiconductor storage device and a controller according to the seventh embodiment;

FIG. 33 is a flowchart showing operations of the semiconductor storage device and the controller according to the seventh embodiment; and

FIG. 34 is a circuit diagram showing a memory cell array according to a modification of the first to seventh embodiments.

### DETAILED DESCRIPTION

According to one embodiment, a semiconductor storage device includes a memory cell array, a plurality of first latch circuits, a first register and a comparator. The memory cell array has a plurality of memory cells associated with columns. The first latch circuits are provided corresponding to the respective columns, and each of the first latch circuits holds data on whether or not the corresponding column has a failure. The first register holds the number of columns for redundancy. The comparator compares the number of the first latch circuits holding the data that the corresponding columns have failures with a criterion based on the data held by the first register. The semiconductor storage device determines whether or not there is a failure in the first latch circuit, based on the result of the comparison by the comparator.

Further embodiments of the invention will be described below with reference to the drawings. In the drawings, the same reference numerals denote the same or similar portions.

A semiconductor storage device, a controller and a memory system according to a first embodiment will be described with reference to the drawings. A three-dimensional stacked NAND flash memory having memory cells stacked on top of a semiconductor substrate will be described below as an example of the semiconductor storage device.

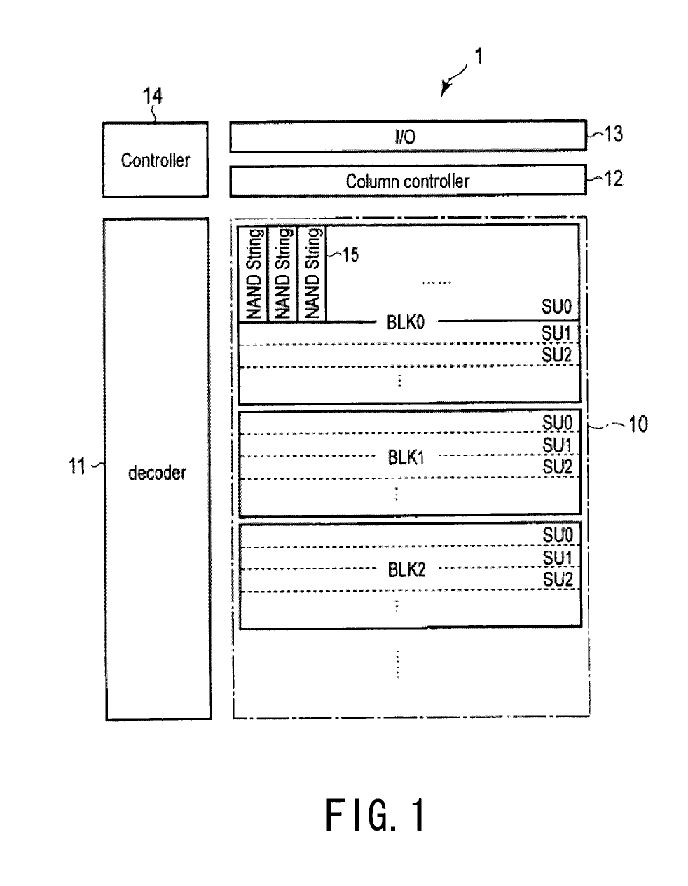

A configuration of the semiconductor storage device will be described with reference to FIG. 1. FIG. 1 is a block diagram of the semiconductor storage device.

As shown in FIG. 1, a semiconductor storage device 1 that is an NAND flash memory includes a memory cell array 10, a decoder 11, a column controller 12, an I/O circuit 13 and a controller 14.

The memory cell array 10 includes a plurality of blocks (e.g., N blocks, however N is an integer of 2 or more) BLK (BLK0, BLK1, BLK2, BLK (n−1)), each block being a set of non-volatile memory cells. Data in the same block BLK is erased collectively. Each of the blocks BLK includes a plurality of string units (e.g., M string units, however M is an integer of 2 or more) SU (SU0, SU1, SU2, . . . ), each string unit being a set of NAND strings 15 having series-connected memory cells. The number of the blocks in the memory cell array 10 and the number of the string units in each block are arbitrary.

The decoder 11 decodes a block address BA received from an externally provided controller, selects a corresponding block BLK, and also applies a predetermined voltage to a word line and a select gate line to be described later.

The column controller 12 senses and amplifies data read from the memory cell during data read. The column controller 12 transfers write data received from the externally provided controller to the memory cell during data write. The data read from and data write into the memory cell array 10 are executed in each of the memory cells, as a unit, and this unit serves as a page. The column controller 12 holds data about failure columns in the memory cell array 10, and accesses normal columns. The column is a set of bit lines. The column controller 12 will be described in detail later.

The I/O circuit 13 transmits and receives various commands and data to and from the externally provided controller.

The controller 14 controls operations of the entire semiconductor storage device 1.

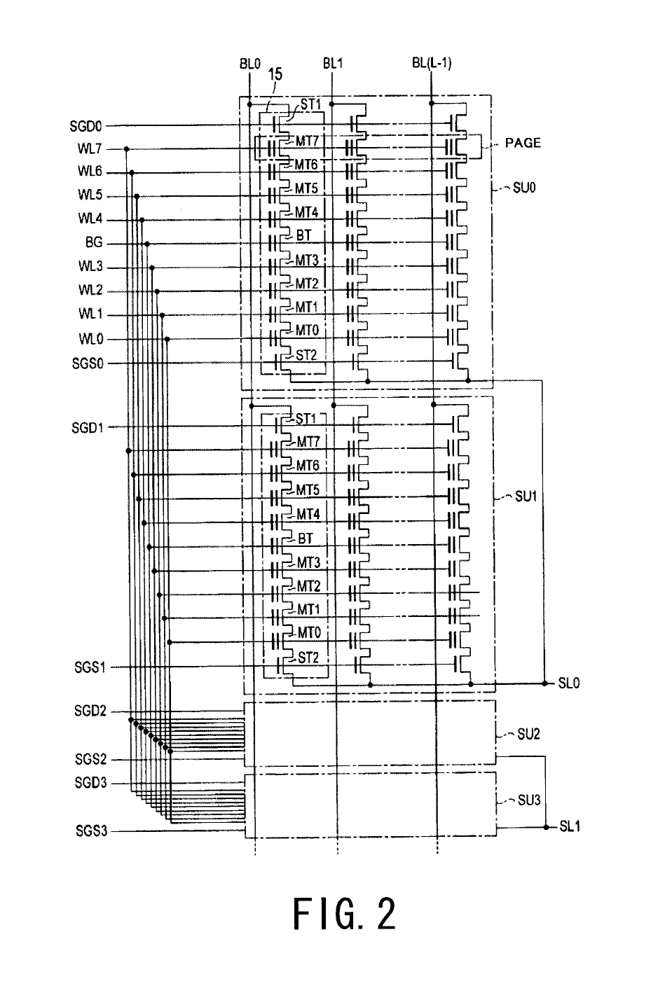

The configuration of the memory cell array 10 will be described in detail with reference to FIG. 2. FIG. 2 is a circuit diagram showing the memory cell array, illustrating one of the blocks BLK. The other blocks BLK also have the same configuration.

As shown in FIG. 2, the block BLK0 has a plurality of string units SU. Each of the string units SU has a plurality of NAND strings 15 (in this embodiment, the number of NAND strings is L).

Each of the NAND strings 15 has eight memory cell transistors MT (MT0 to MT7), a select transistor ST1 (first select transistor), a select transistor ST2 (second select transistor), and a back gate transistor BT, for example. The memory cell transistor MT has a stacked gate including a control gate and a charge storage layer, and holds data in a non-volatile manner. The number of the memory cell transistors MT is set to 8, but is not necessarily limited thereto. The number of the memory cell transistors may be 16, 32, 64, or 128, for example. The back gate transistor BT has a stacked gate including a control gate and a charge storage layer as in the case of the memory cell transistor MT. The back gate transistor BT does not hold data but functions simply as a current path during data write and erase. The memory cell transistors MT and the back gate transistor BT are arranged between the select transistors ST1 and ST2, so that the current paths thereof are connected in series. Here, the back gate transistor BT is provided between the memory cell transistors MT3 and MT4. The current path of the memory cell transistor MT7 at one end of the series-connected memory cell transistors MT and back gate transistor BT is connected to one end of the current path of the select transistor ST1. The current path of the memory cell transistor MT0 at the other end of the series-connected memory cell transistors MT and back gate transistor BT is connected to one end of the current path of the select transistor ST2.

Gates of the select transistors ST1 provided in the string units SU0 to SU(M−1) are commonly connected to select gate lines SGD0 to SGD(M−1), respectively. Gates of the select transistors ST2 provided in the string units SU0 to SU(M−1) are commonly connected to select gate lines SGS0 to SGS(M−1), respectively. The control gates of the memory cell transistors MT0 to MT7 in the same block BLK0 are commonly connected to word lines WL0 to WL7, respectively. The control gates of the back gate transistors BT in the same block BLK0 are commonly connected to a back gate line BG0.

The word lines WL0 to WL7 and the back gate line BG are commonly connected between the plurality of string units SU in the same block BLK0. The select gate line SGD and the select gate line SGS are independent for each of the string units SU even within the same block BLK0.

The other ends of the current paths of the select transistors ST1 of the NAND strings 15 in the same column, among the NAND strings 15 arranged in a matrix within the memory cell array 10, are commonly connected to any of bit lines BL. The bit line BL commonly connects the plurality of NAND strings 15 in the same block BLK, and also commonly connects the NAND strings 15 between the blocks BLK. The other ends of the current paths of the select transistors ST2 are connected to any of source lines SL. The source line SL commonly connects the NAND strings 15 between the string units SU, for example.

As described above, the data in the memory cell transistors MT in the same block BLK are collectively erased. The data read and write are executed collectively for the memory cell transistors MT commonly connected to any of the word lines WL in the string units SU in the block BLK. This unit serves as a “page”.

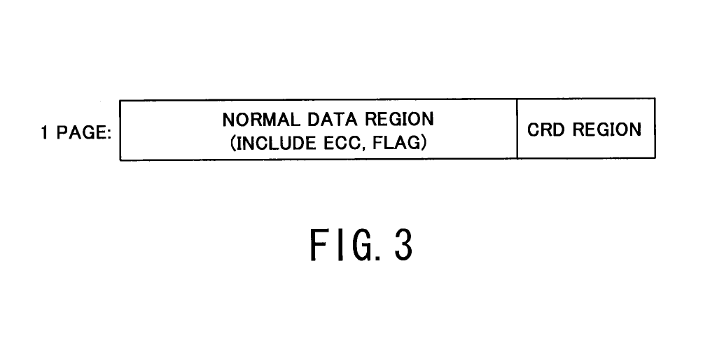

A one-page configuration will be described with reference to FIG. 3. FIG. 3 is a schematic diagram showing the one-page configuration.

As shown in FIG. 3, one page has a normal data region and a CRD (column redundancy) region. The CRD region is a region to replace failure columns. In the normal data region, data (e.g., parity) to correct an ECC (error correcting code), for example, and data such as a flag indicating how many bits of data is held by each of the memory cell transistors, are stored.

In the memory cell array 10 having the above configuration, the memory cell transistors MT, the select transistors ST1, the select transistors ST2 and the back gate transistors BT are three-dimensionally stacked above a semiconductor substrate. As an example, a part of a peripheral circuit such as the column controller 12, for example, is formed on top of the semiconductor substrate, and the memory cell array 10 is formed above the peripheral circuit.

The configuration of the memory cell array 10 is described in U.S. patent application Ser. No. 12/407,403, “Three Dimensional Stacked Nonvolatile Semiconductor Memory”, for example, filed on Mar. 19, 2009. The configuration of the memory cell array 10 is also described in U.S. patent application Ser. No. 12/406,524, “Three Dimensional Stacked Nonvolatile Semiconductor Memory”, filed on Mar. 18, 2009, U.S. patent application Ser. No. 12/679,991, “Nonvolatile Semiconductor Storage Device and Method of Manufacturing the Same”, filed on Mar. 25, 2010, and U.S. patent application Ser. No. 12/532,030, “Semiconductor Memory and Method For Manufacturing the Same”, filed on Mar. 23, 2009. The entireties of the above patent applications are incorporated herein by reference.

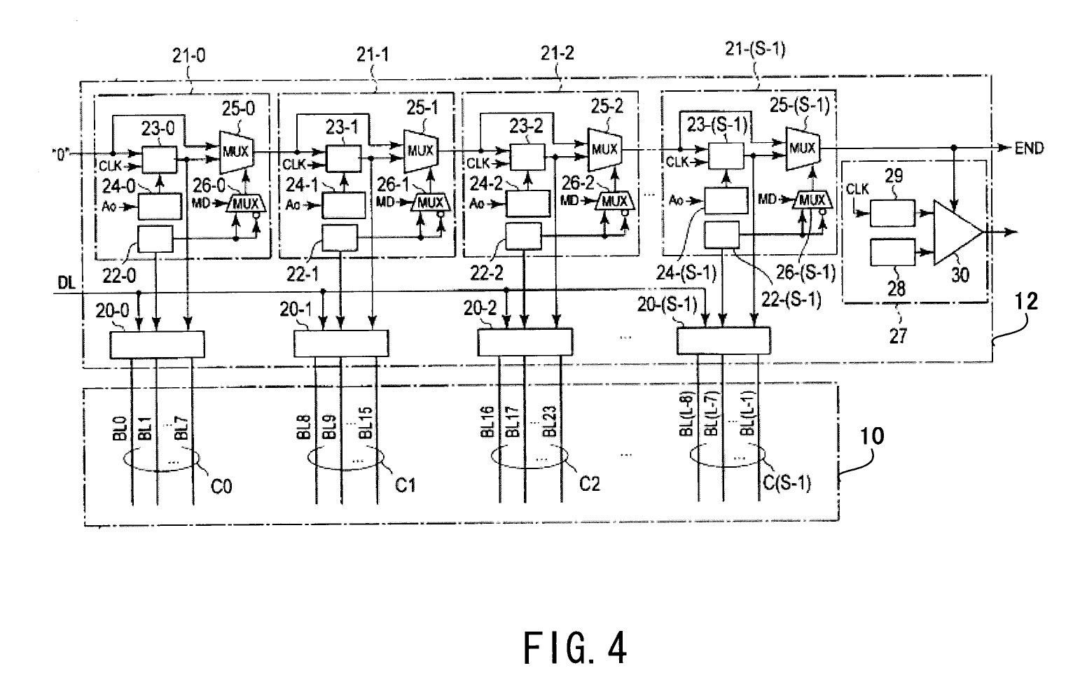

The column controller 12 will be described with reference to FIG. 4. FIG. 4 is a block diagram showing the column controller.

The column controller 12 handles the memory cell array 10 by the column. First, the column will be described with reference to FIG. 4.

The memory cell array 10 includes L bit lines BL0 to BL(L−1). Eight adjacent bit lines BL, for example, in the order from the bit line BL0 constitute one column. The memory cell array 10 includes S columns C0 to C(S−1) (however S is an integer of 2 or more). The bit lines BL8i to 8L(8i+7) belong to the column Ci (i is an integer). The column C0 includes the bit lines BL0 to BL7, the column C1 includes the bit lines BL8 to BL15, and the column C(S−1) includes the bit lines BL(L−8) to BL(L−1). The replacement of failure columns described above is performed by the column.

As shown in FIG. 4, the column controller 12 has a plurality of latch circuits 20 (20-0 to 20-(S−1)) (a plurality of third latch circuits) and selection units 21 (21-0 to 21-(S−1)), both of which correspond to the columns C0 to C(S−1), respectively, and a comparison unit 27.

The latch circuit 20-i corresponds to the column Ci, that is, the bit lines BL8i to 8L(8i+7), and holds data. The latch circuit 20-i temporarily holds data read onto the bit lines BL8i to 8L(8i+7) during data read, and then outputs the read data to a data line DL. The latch circuit 20-i temporarily holds write data given by the data line DL during data write, and then transfers the data to the bit lines BL8i to 8L(8i+7).

The selection units 21 will be described. The selection unit 21-i corresponds to the latch circuit 20-i, that is, the column Ci, and activates the corresponding latch circuit 20-i. The latch circuit 20-i is activated by the corresponding selection unit 21-i to be able to input and output data.

The respective selection units 21 have latch circuits 22 (22-0 to 22-(S−1)) (a plurality of first latch circuits), 23 (23-0 to 23-(S−1)) (a plurality of second latch circuits), decoders 24 (24-0 to 24-(S−1)), selection circuits 25 (25-0 to 25-(S−1)) (first selection circuits), and selection circuits 26 (26-0 to 26-(S−1)).

The latch circuit 22-i holds data on whether or not the corresponding column Ci has a failure. The latch circuits 22 are also referred to as isolation latches. The latch circuit 22-i holds “0”, for example, when the corresponding column Ci has a failure, and holds “1” when the corresponding column Ci is normal. The latch circuit 22-i holds “0” also when the corresponding column is a column for redundancy (also called “redundancy column”) and is unused. Such “0”/“1” relationship may be reversed. Note that the latch circuits 20 are also referred to as data latches.

The latch circuit 23-i holds a pointer (e.g., “1”) to determine when to activate the corresponding latch circuit 20-i. The latch circuits 23 retrieve input data in synchronization with a rising edge, for example, of a clock CLK. The latch circuits 23 are collectively initialized by a control signal given by the controller 14, for example. By the initialization, all the data held by the latch circuits 23 are set to “0”.

The decoder 24-i decodes an internal column address A₀ generated by the controller 14, for example. When the internal column address A₀ indicates the corresponding column Ci, a pointer is forcibly set in the latch circuit 23-i. This means that the latch circuit 23-i holds “1”.

The selection circuit 26-i selects between the data held by the latch circuit 22-i and inverted data, based on a control signal MD. The control signal MD is a signal that specifies an operation mode of the column controller 12. The column controller 12 has a first skip mode to skip a column (failure column) in which the latch circuit 22 is set, and a second skip mode to skip a column (normal column) in which the latch circuit 22 is not set. The control signal MD specifies which one of the modes is to be adopted. The selection circuit 26 selects the data in the latch circuit 22 in the first skip mode, and selects the inverted data in the latch circuit 22 in the second skip mode.

The selection circuit 25-i selects between the data held in the latch circuit 23-i and the input data to the latch circuit 23-i (that is, the output data from the preceding selection unit 21-(i−1)), based on the data selected by the selection circuit 26-i. To be more specific, when the latch circuit 22-i holds “1”, the data held by the latch circuit 23-i is selected and outputted. On the other hand, when the latch circuit 22-i holds “0”, the input data to the latch circuit 23-i is selected and outputted. In the first skip mode, when the latch circuit 22-i holds “0” (i.e., when the latch circuit 22-i indicates that the corresponding column is a failure column), the latch circuit 23-i is skipped. In the second skip mode, on the other hand, when the latch circuit 22-i holds “1” (i.e., when the latch circuit 22-i indicates that the corresponding column is a normal column), the latch circuit 23-i is skipped.

In the above configuration, the selection units 21-0 to 21-(S−1) are sequentially connected in series so that the output from the selection circuit 25-i is given to the latch circuit 23-(i+1) and the selection circuit 25-(i+1) in the next stage. Note that “0” is inputted to the latch circuit 23-0 in the selection unit 21-0 in the first stage, and a signal END is outputted from the selection unit 21-(S−1) in the last stage.

The data (“1” or “0”) held by the latch circuit 22-i and the latch circuit 23-i is given to the latch circuit 20-i. When the latch circuit 22-i and the latch circuit 23-i both hold “1”, the latch circuit 20-i is activated. The activated latch circuit 20-i retrieves write data during data write, and outputs read data during data read. When the latch circuit 22-i has “0” or the latch circuit 23-i has “0”, the latch circuit 20-i is not activated.

The comparison unit 27 includes a register 28 (first register), a counter 29 and a comparator 30. The comparison unit 27 is activated in the second skip mode.

The register 28 holds an implemented column redundancy (CRD) number, as a criterion. The implemented CRD number is the number of redundancy columns provided to replace failure columns therewith.

The counter 29 counts up (or counts down) in synchronization with the clock CLK.

The comparator 30 compares the criterion held by the register 28 with the count by the counter 29, and outputs the comparison result to the controller 14.

Next, an acquired failure detection operation will be described. Acquired failures described in the embodiment mean the following defects.

Specifically, when there is a failure column as described above, the column is replaced with a redundancy column. A failure column (an innate failure) is identified at the time of manufacture of the semiconductor storage device 1 that is the NAND flash memory, and the address data of the innate failure column is recorded in a ROM fuse of the NAND flash memory. Therefore, the controller can handle the innate failure by reading the ROM fuse.

On the other hand, the acquired failure in the embodiment means a failure in the latch circuit 22 that occurs after the manufacture (after write into the ROM fuse). The acquired failures include a failure occurring while a user is using the semiconductor storage device 1 that is the NAND flash memory after shipment. Such a failure in an isolation latch is not registered in the ROM fuse, and is thus detected by the acquired failure detection operation described below.

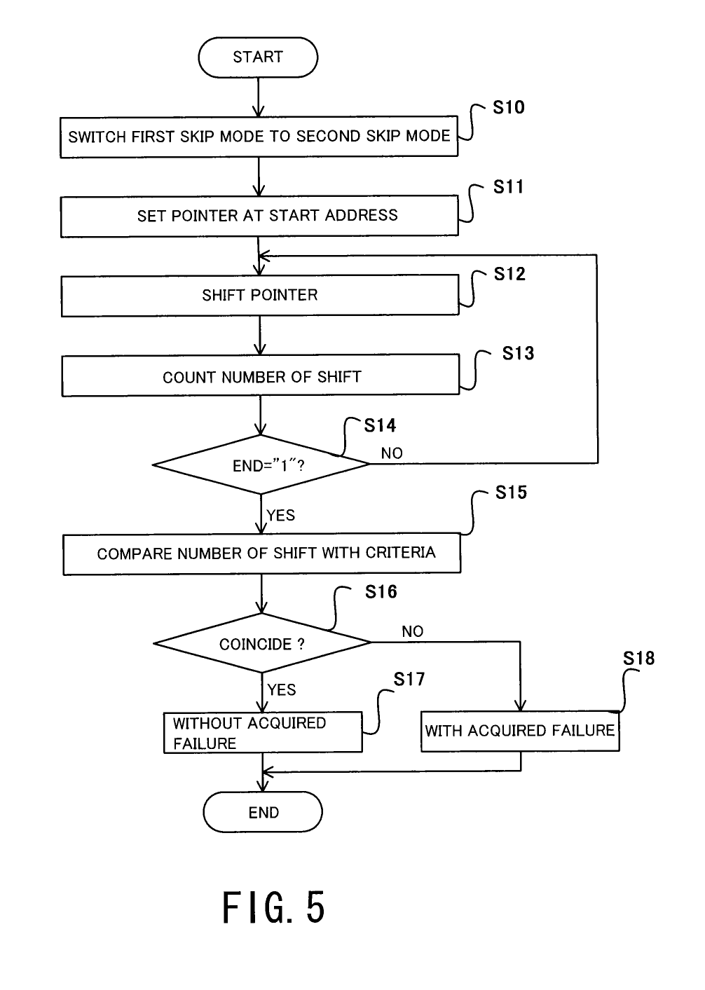

The acquired failure detection operation will be described with reference to FIG. 5. FIG. 5 is a flowchart showing a failure detection method, which is performed under the control of the controller 14.

As shown in FIG. 5, the controller 14 switches the operation mode of the column controller 12 from the first skip mode to the second skip mode by switching the control signal MD (Step S10). As a result, the selection circuit 28 selects an inverted signal of the latch circuit 22.

Next, the controller 14 sets a pointer at a start address (Step SM. The start address means the latch circuit 23 corresponding to the latch circuit 22, which is positioned on the uppermost stream side of the series connection of the selection units 21 (i.e., which has the smallest column address) among the latch circuits 22 holding “0”, for example.

Subsequently, the controller 14 shifts the pointer while skipping the latch circuits 23 corresponding to the latch circuits 22 holding “1” by issuing a clock CLK (Step S12). The counter 29 counts the number of shifts in synchronization with the clock CLK (Step S13).

Thereafter, the pointer shift operation (Step S12) and the count operation (Step S13) are repeated until a signal END is outputted (END=“1”) (Step S14).

Next, when the signal END is outputted (“YES” in Step S14), the comparator 30 compares the counter value of the counter 29 at that point with the criterion in the register 29, in response to the signal END (Step S15). The comparison result is outputted to the controller 14.

Subsequently, when the both coincide (“YES” in Step S16) in the comparison result, the controller 14 determines that there is no acquired failure in the latch circuits 22 (Step S17). On the other hand, when the both do not coincide (“NO” in Step S16), the controller 14 determines that there is an acquired failure in any of the latch circuits 22 (Step S18).

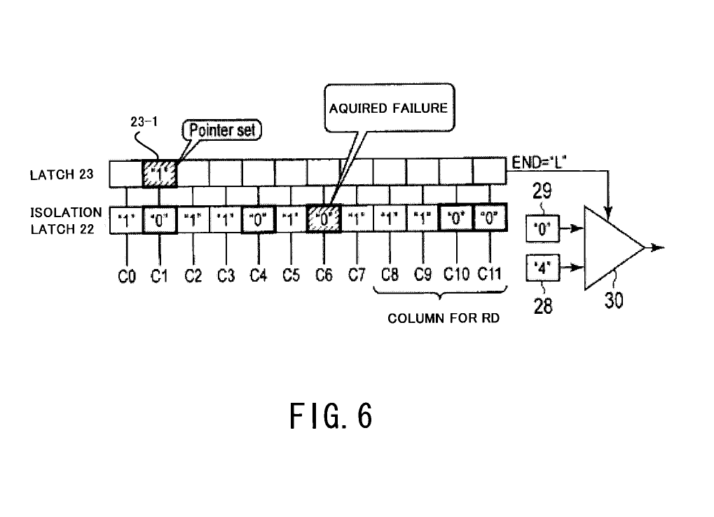

A specific example of the acquired failure detection operation will be described with reference to FIGS. 6 to 11. FIGS. 6 to 11 are block diagrams showing operations of the column controller 12 during the acquired failure detection operation. For ease of explanation, the following description is given of a case, as an example, where the columns in the normal data region are eight columns C0 to C7 and the columns in the redundancy region are four columns C8 to C11. More specifically, the implemented column redundancy number is “4”, which is held in the register 28.

As shown in FIG. 6, there are innate column failures in the columns C1 and C4. Thus, the latch circuit 22-1 and the latch circuit 22-4 hold “0”. The columns C1 and C4 are replaced with the redundancy columns C8 and C9, respectively. Since the redundancy columns C10 and C11 are not used, the corresponding latch circuits 22-10 and 22-11 also hold “0”. Even though there is an acquired failure in the latch circuit 22-6 corresponding to the column C6 and the column C6 is a normal column, the latch circuit 22-6 holds “0”.

First, the controller 14 sets a pointer in the latch circuit 23-1 corresponding to the innate failure column C1. “1” is given to the latch circuit 23-1. The controller 14 issues a clock CLK.

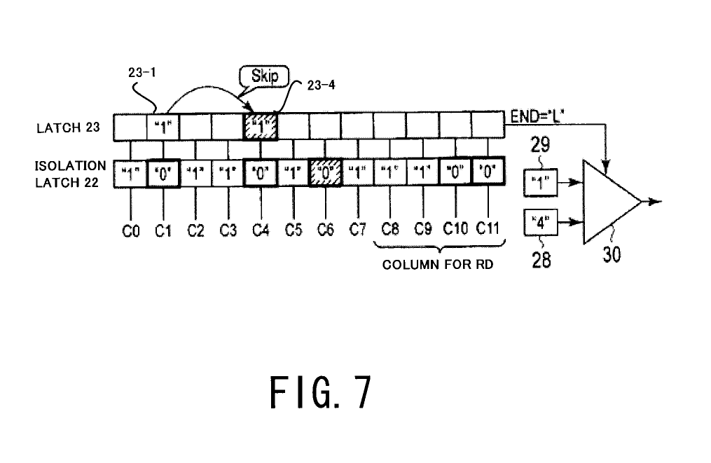

After the issuance of the clock CLK, the pointer is transferred to the latch circuit 23-4 corresponding to the failure column C4 in a clock CLK cycle, as shown in FIG. 7. This transfer is for the selection circuit 26 to select the inverted signal of the latch circuit 22, and to skip the latch circuits 23-2 to 23-5 corresponding to normal columns. The counter value of the counter 29 is counted up from “0” to “1”.

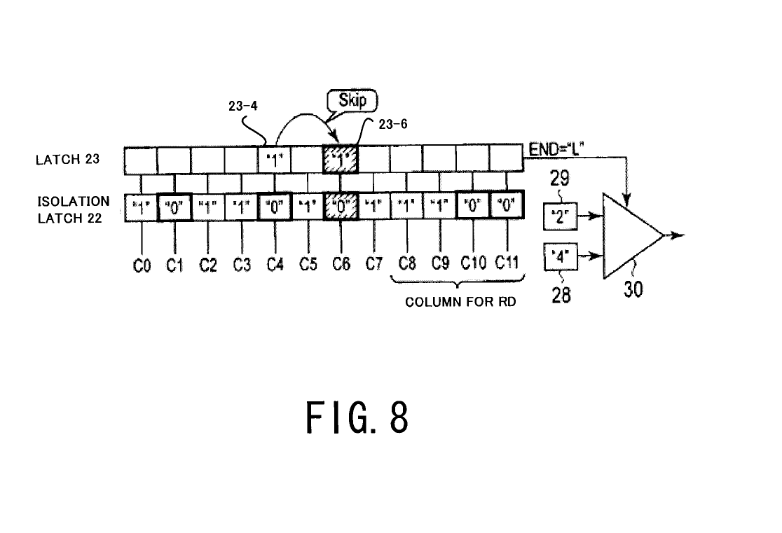

When the clock CLK is inputted after the count-up, the pointer is transferred to the latch circuit 23-6 corresponding to the latch circuit 22-6 with an acquired failure, as shown in FIG. 8. The counter value of the counter 29 is counted up from “1” to “2”.

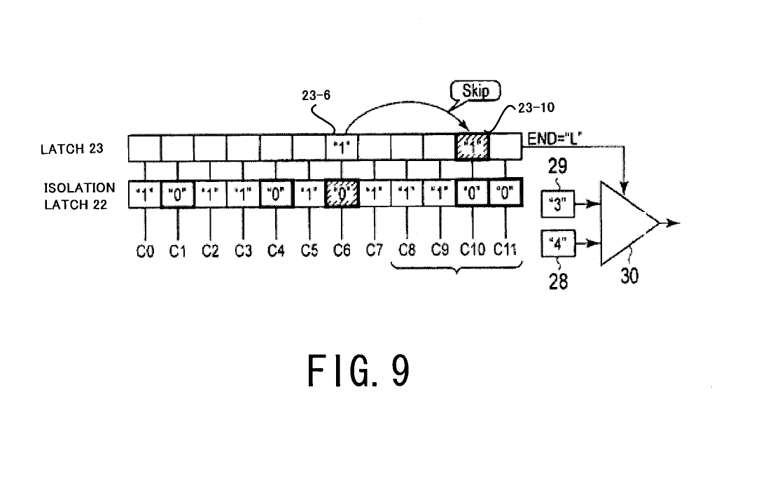

When the clock CLK is inputted after the count-up to “2”, the pointer is transferred to the latch circuit 23-10 corresponding to the unused redundancy column C10, as shown in FIG. 9. The counter value of the counter 29 is counted up from “2” to “3”.

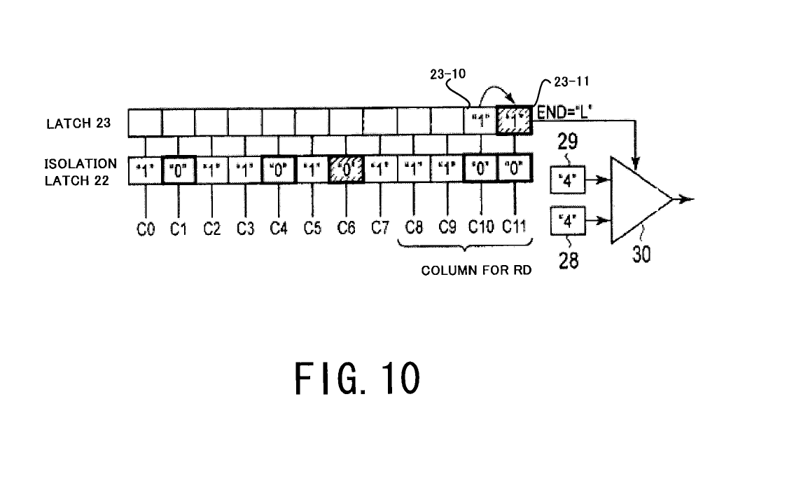

When the clock CLK is inputted after the count-up to “3”, the pointer is transferred to the latch circuit 23-11 corresponding to the unused redundancy column C11, as shown in FIG. 10. The counter value of the counter 29 is counted up from “3” to “4”.

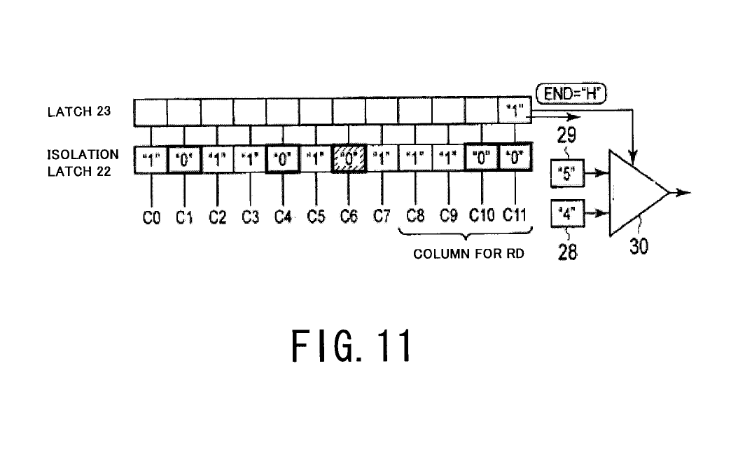

When the clock CLK is inputted after the count-up to “4”, the pointer is outputted as a signal END to set END=“1” as shown in FIG. 11. The counter value of the counter 29 is counted up from “4” to “5”. The comparator 30 compares the criterion “4” held in the register 28 with the counter value “5” of the counter 29. Since the both do not coincide, the comparator 30 transfers the data to the controller 14.

Advantageous effects of the semiconductor storage device according to the embodiment will be described.

In a Column Skip-RD (Column Skip Redundancy) method, failure columns, if any, are skipped and CRD (Column Redundancy) is used at the end of the page, thereby covering shortfall in the number of columns caused by skipping. When the latch (Isolation Latch) indicating the column to be skipped is an acquired failure, the data in the column can no longer be read as well as the data in the subsequent columns are all displaced. As a result, the data cannot be corrected using an error detection and correction function. Moreover, the number of columns per page becomes too large or too small.

Even when an acquired Isolation failure (a failure occurring in an isolation latch) occurs, there is no way of detecting the failure before the user operation. When it can be determined whether or not there is an acquired Isolation failure, where the failure is, and whether the failure is in a “constant Isolation state” or “constant non-Isolation state”, the data written before the occurrence of the failure can be saved. However, when the data is continuously written without the failure being noticed, saving of the data becomes difficult.

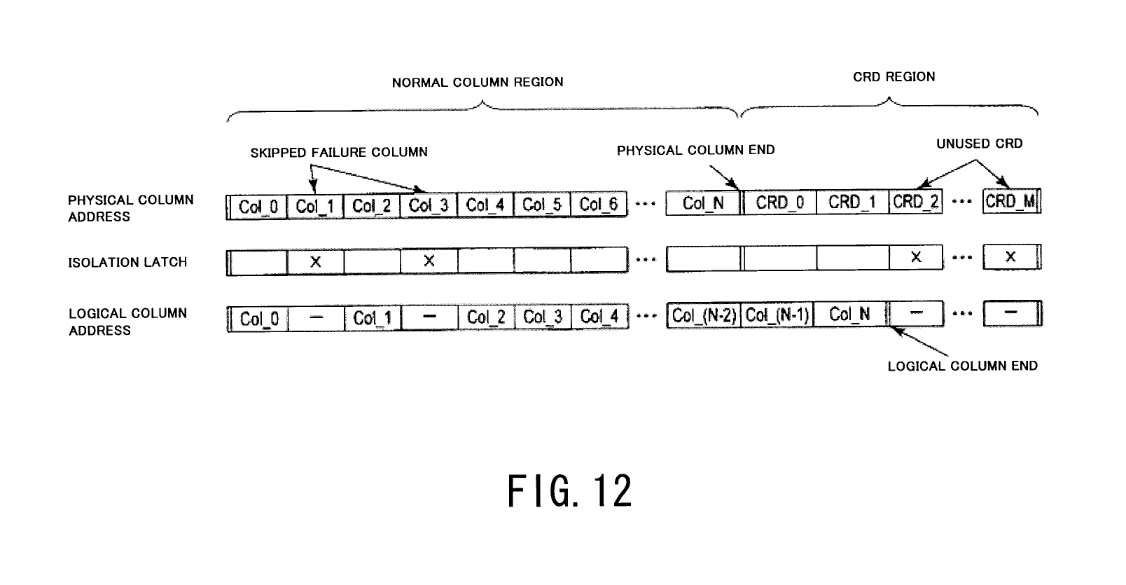

This situation will be described with reference to FIGS. 12 to 14. FIGS. 12 to 14 are block diagrams showing the column controller. In FIG. 12, a physical column address Col_0 and a physical column address Col3 are innate failure columns, which are replaced with a redundancy column CRD_0 and a redundancy column CRD_1. Thus, a final address COL_N of a logical column address corresponds to the redundancy column CRD_1. Meanwhile, redundancy columns CRD_2 to CRD_M are not used.

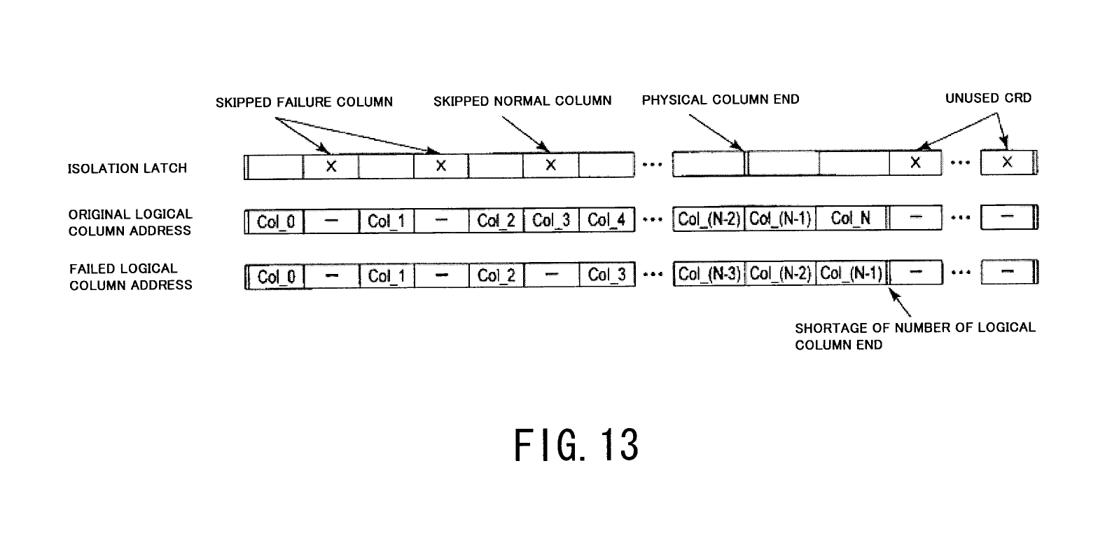

FIG. 13 shows a situation where an acquired failure occurs in an isolation latch corresponding to a physical column address Col_5 in the above state. As shown in FIG. 13, even though the column corresponding to the physical column address Col_5 is a normal column, isolation is set and thus the physical column address Col_5 is skipped. As a result, a logical column address of the redundancy column CRD_1 becomes Col_(N−1), and the number of columns falls short. In other words, there is no column corresponding to the logical column address Col_N.

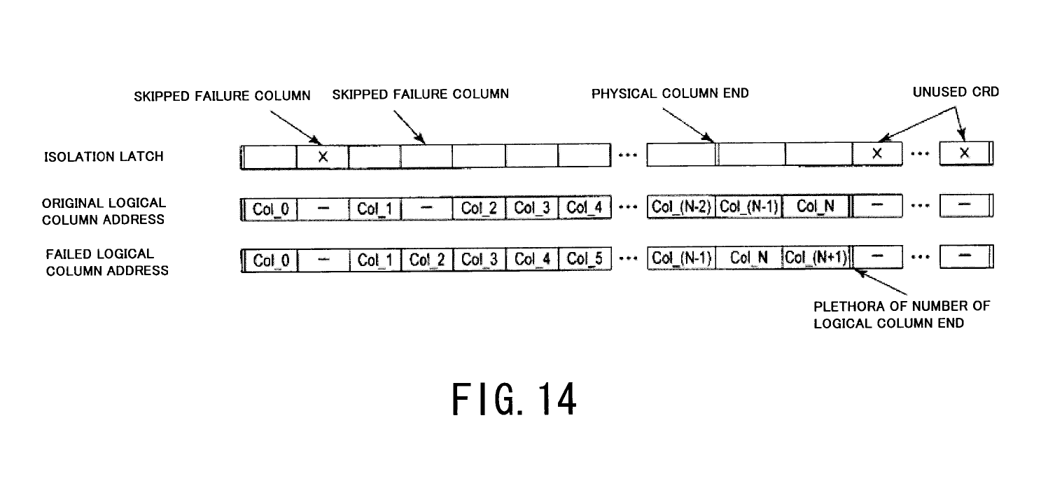

FIG. 14 shows a situation where, contrary to the situation shown in FIG. 13, an acquired failure occurs in an isolation latch corresponding to the column Col_3 that is an innate failure column, and the set isolation is reset.

As shown in FIG. 14, even though the column corresponding to the physical column address Col_3 has a failure, isolation is not set. Accordingly, the physical column address Col_3 is not skipped, and erroneous data is read or data can no longer be normally written. Consequently, the logical column address of the redundancy column CRD_1 becomes Col_(N+1), resulting in an excessive number of columns.

The problems as described above can be classified into the following two types.

(Problem 1) When an acquired Isolation failure occurs, a fatal data failure occurs during read.

(Problem 2) There is no way of detecting in advance an acquired Isolation failure in user usage.

As to the above two problems, (Problem 1) is resolved by solving (Problem 2). However, on the other hand, (Problem 1) is not resolved unless (Problem 2) is solved. Since the acquired Isolation failure problem is based on the assumption of user usage, highest priority requirements as a solution to (Problem 2) are as follows.

(Condition 1) Failures can be identified before execution of write or read.

(Condition 2) Failures are identified at least immediately after power activation to meet (Condition 1)

(Condition 3) Failures can be identified during POR to meet (Condition 2).

(Condition 4) High-speed detection is required to enable POR.

Based on the above problems, in the embodiment, it is checked whether or not there is an acquired Isolation failure by using the characteristics that the implemented CRD number and the total number of isolation latches set (which hold “0”) always coincide.

First, the above characteristics will be described. When there is no failure column, all the redundancy columns CRD are not used. Thus, isolation latches are set for all CRD. This is referred to as isolation set. When Isolation set is performed for failure columns, Isolation set is performed for the number of CRD, which is obtained by subtracting the number of the failure columns from the total number of CRD. Accordingly, the number of CRD for which Isolation set is performed always coincides with the number of CRD prepared.

When the implemented CRD number is 25, for example,

a) When there is no failure column: Isolation set for 25 unused CRD
i.e., 25 isolation latches in total are set.

b) When there is 1 failure column: Isolation set for 1 failure column and 24 unused CRD i.e., 25 isolation latches in total are set.

c) When there are 2 failure columns: Isolation set for 2 failure columns and 23 unused CRD i.e., 25 isolation latches in total are set.

d) When there are 25 failure columns: Isolation set for 25 failure columns (no Isolation set for CRD)
i.e., 25 isolation latches in total are set.

With the above characteristics, it is determined whether or not the total number of isolation latches set coincides with the implemented CRD number as a criterion. Thus, a simple Isolation Checker can be realized.

The semiconductor storage device according to the embodiment has the first skip mode and the second skip mode. The first skip mode is a normal operation mode to skip columns for which isolation latches are set. On the other hand, the second skip mode is a mode to skip columns for which no isolation latches are set.

As described with reference to FIGS. 6 to 11, the number of clocks until the signal END is outputted (the pointer is outputted) is counted while skipping the columns for which the latch circuits 22 are not set. Thus, the number of isolation latches set can be counted. When the result of comparison between the count number and the implemented CRD number shows that the both do not coincide, this means that any of the isolation latches has a failure.

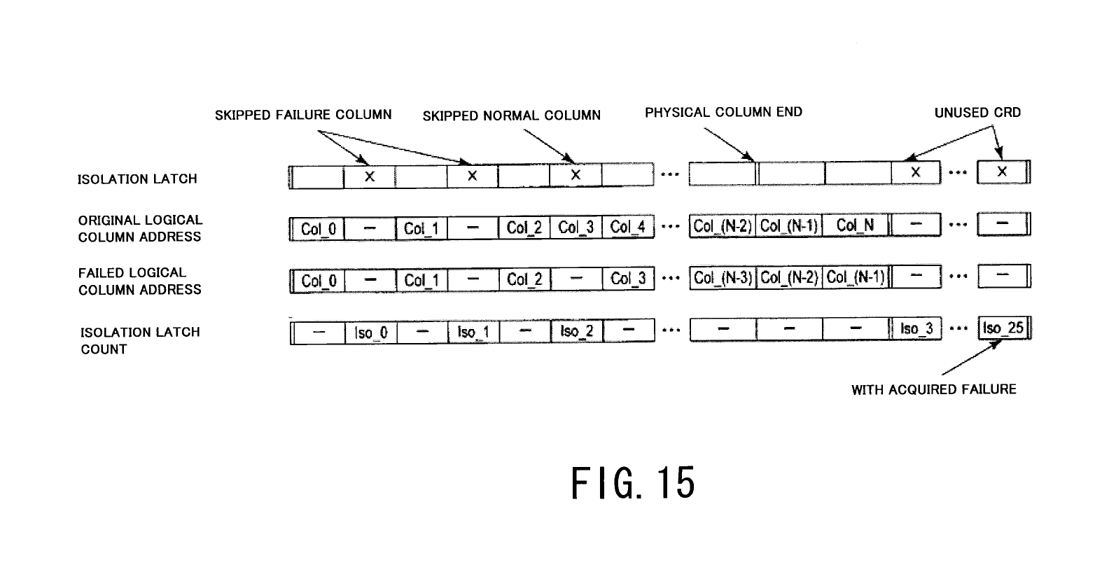

The above situation will be described with reference to FIG. 15. FIG. 15 is a block diagram showing the column controller. In FIG. 15, “Normal Isolation Column Skip” corresponds to the first skip mode described above, and “No Isolation Column Skip” corresponds to the second skip mode.

According to the method, when the implemented CRD number, for example, is 25, a detection result on whether or not there is a failure in the latch circuits 22 can be obtained by shifting the pointer 25 times. Thus, time required for the detection operation is 20 ns×25=0.5 is when 1 cycle of the clock CLK is 20 ns, for example, 80 ns×25=2 is in a case of 80 ns, and 240 ns×25=6 μs in a case of 240 ns.

As described above, the semiconductor storage device according to the embodiment can quickly detect a failure in the isolation latch. The acquired failure detection operation immediately after a POR (power on read) operation performed immediately after power activation of the semiconductor storage device 1 that is the NAND flash memory makes it possible to check whether or not there is an acquired failure every time the power is turned on. Note that the POR operation is an ROM fuse data read operation spontaneously performed by the semiconductor storage device 1 without receiving a read command from the controller.

A semiconductor storage device, a controller and a memory system according to a second embodiment will be described with reference to the drawings. The embodiment uses a batch detection operation to perform the acquired failure detection operation described in the first embodiment. Hereinafter, only differences from the first embodiment will be described.

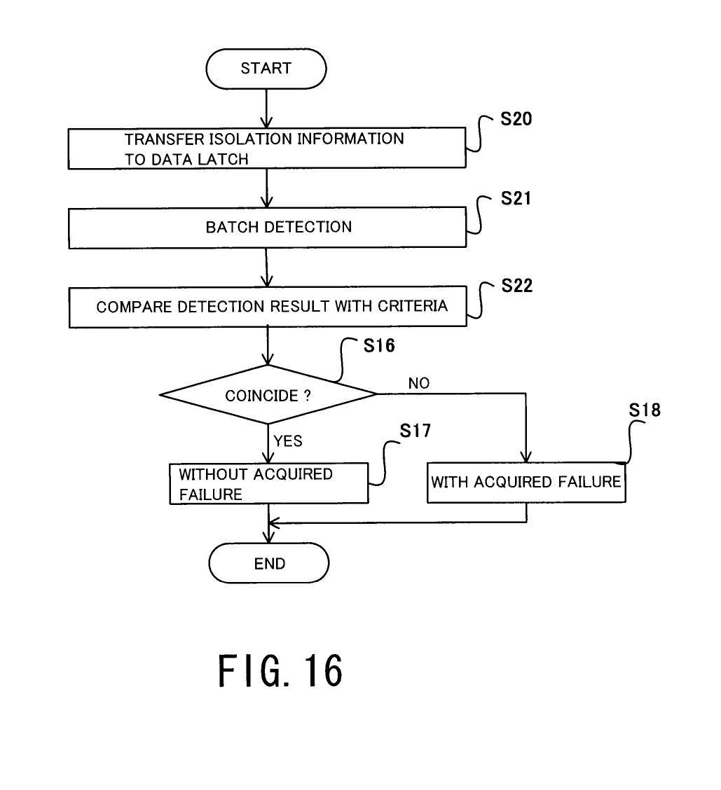

An acquired failure detection operation according to the embodiment will be described with reference to FIG. 16. FIG. 16 is a flowchart showing a failure detection method, more particularly showing operations of a column controller 12. In the embodiment, the operations shown in FIG. 16 are performed under the control of a controller 14 as in the case of the first embodiment.

As shown in FIG. 16, the controller 14 transfers all data (referred to as isolation data) held in a latch circuit 22-i to a corresponding latch circuit 20-i (Step S20).

Next, the controller 14 uses a batch detection function to detect the number of bits indicating a failure column (and unused redundancy columns) in the latch circuit 20 (Step S21). A comparator 30 compares the detection result with a criterion held by the register 28 (Step S22).

Subsequently, when the comparison result shows that the both coincide (“YES” in Step S16), the controller 14 determines that there is no acquired failure (Step S17). On the other hand, when the both do not coincide (“NO” in Step S16), the controller 14 determines that there is an acquired failure in any of the columns (Step S18).

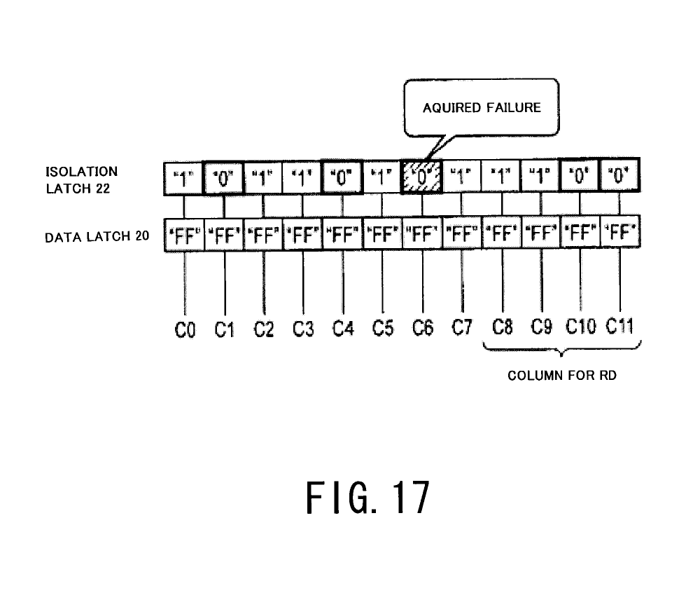

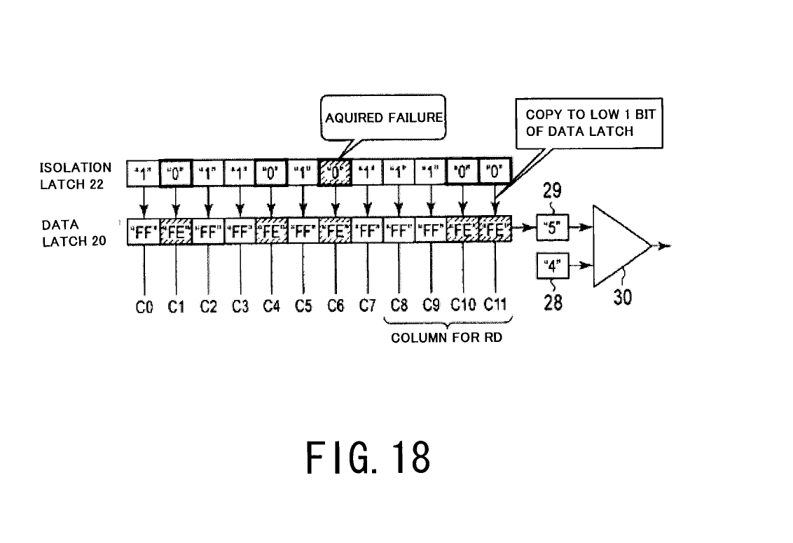

A specific example of the acquired failure detection operation will be described with reference to FIGS. 17 and 18. FIGS. 17 and 18 are block diagrams showing operations of the column controller. In the embodiment, description is given of a case, as an example, where the columns in the normal data region are eight columns C0 to C7 and the columns in the redundancy region are four columns C8 to C11, as in the case of the first embodiment. More specifically, the implemented column redundancy number is “4”, which is held in the register 28.

As shown in FIG. 17, there are innate column failures in the columns C1 and C4. Thus, the latch circuit 22-1 and the latch circuit 22-4 hold “0”. Since the redundancy columns C10 and C11 are not used, the corresponding latch circuits 22-10 and 22-11 hold “0”. Even though there is an acquired failure in the latch circuit 22-6 corresponding to the column C6 and the column C6 is a normal column, the latch circuit 22-6 holds “0”.

First, the controller 14 resets the latch circuits 20 to store data “1” in all the latch circuits 20. In the embodiment, since one column includes 8 bit lines, each of the latch circuits 20 holds 8-bit data. Thus, each of the reset latch circuits 20 holds data “FF” in hexadecimal notation.

Next, the controller 14 transfers the data in the latch circuits 22 to the latch circuits 20 as shown in FIG. 18. Each of the latch circuits 22 holds 1-bit data. Therefore, the controller 14 copies the 1-bit isolation data to the least significant bit of the 8-bit data in each of the latch circuits 20.

As a result, in the column where the latch circuits 22 hold “1”, the data in the latch circuits 20 remains as “FF”. On the other hand, in the column where the latch circuits 22 hold “0”, the data in the latch circuits 20 changes from “FF” to “FE”. In other words, the least significant bit is inverted from “1” to “0”.

Subsequently, the controller 14 collectively detects the number of bits with “0” in the latch circuits 20. The comparator 30 compares the result of the batch detection with the criterion. In FIG. 18, the batch detection result is “5” and the criterion is “4”, which shows that there is an acquired failure in any of the latch circuits 22.

As described above, in the semiconductor storage device according to the embodiment, the time required for the acquired failure detection operation can be reduced to not more than several us to ten μs, for example. Thus, the detection operation can be further speeded up.

A semiconductor storage device, a controller and a memory system according to a third embodiment will be described with reference to the drawings. The embodiment uses batch detection to perform the acquired failure detection operation described in the first embodiment. Hereinafter, only differences from the first embodiment will be described. Moreover, the embodiment responds to an extended column mode in the first and second embodiments. Hereinafter, only differences from the first and second embodiments will be described.

An operation mode for column redundancy will be described. A semiconductor storage device 1b that is an NAND flash memory according to the embodiment includes a normal mode and an extended column mode for column redundancy.

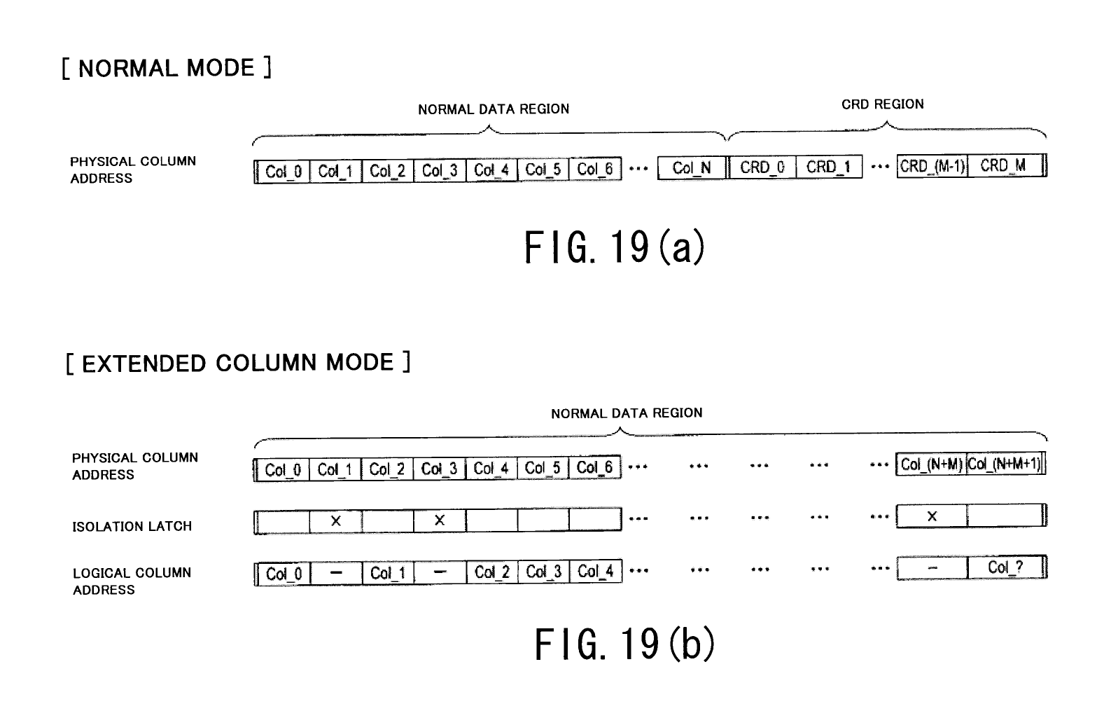

A column controller will be described with reference to FIGS. 19(a) and 19(b). FIGS. 19(a) and 19(b) are block diagrams showing the column controller, FIG. 19 (a) schematically showing the normal mode and FIG. 19 (b) schematically showing the extended column mode.

As shown in FIG. 19 (a), in the normal mode, a column redundancy region is provided separately from a normal data region, as described in the first and second embodiments. In this case, the number of columns that can be saved is equal to the number of columns in the CRD region. In the case of FIG. 19 (a), a failure occurring in any of the (N+1) columns in the normal data region is replaced with any of the (M+1) columns in the column redundancy region. Therefore, the maximum number of columns that can be saved is (M+1).

Meanwhile, in the extended column mode, there is no column redundancy region and all the columns are treated as the normal data region, as shown in FIG. 19 (b). Thus, more (e.g., 256) failure columns can be saved, compared with the normal mode, thereby improving the yield of the semiconductor storage device 1b that is the NAND flash memory. However, when the number of columns used for the replacement of the failure columns is increased, the number of columns per page becomes smaller than the original number ((N+1) in the example of FIG. 19). Such a situation can be handled by a controller of the semiconductor storage device 1b that is the NAND flash memory.

Moreover, in the normal mode, an end column (a column closer to the final address) in the column redundancy region is treated as an unused redundancy column, and isolation setting is performed for the columns. “0” is stored in the latch circuits 22. As a result, the total number of columns for which the isolation setting is performed is always constant ((M+1) in the case of FIG. 19 (a)).

On the other hand, in the extended column mode, since such setting is not performed, the number of usable columns varies from one chip to another depending on the result of test process. When the maximum number of columns for which the isolation setting can be performed is 256, for example, the number of columns subjected to isolation setting becomes 0 in the best chip. Thus, all of the (M+N+2) columns become usable. On the other hand, in the worst chip, the number of columns subjected to isolation setting becomes 256, and only (M+N-256) columns become usable.

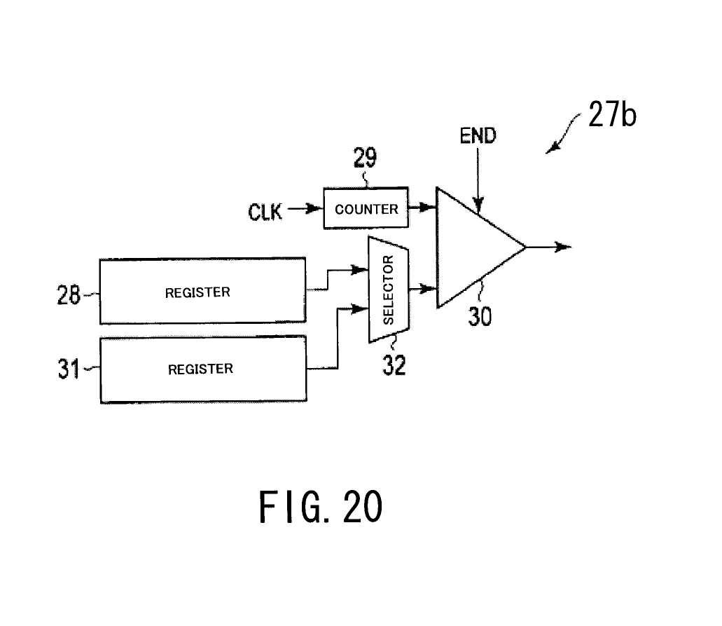

A configuration of a comparison unit will be described with reference to FIG. 20. FIG. 20 is a block diagram showing the comparison unit.

As shown in FIG. 20, a comparison unit 27b includes a register 28, a counter 29, a comparator 30, a register 31 and a selector 32.

The register 31 (a second register) holds the isolation setting number in the extended column mode. The isolation setting number is stored in the memory cell array 10 as ROM fuse data, for example, and is set in the register 31 by the controller 14 at the time of POR. Alternatively, the isolation setting number may be set by an external controller.

The selector 32 selects the CRD implementation number in the register 28 in the normal mode, and selects the isolation setting number in the register 31 in the extended column mode. The selector 32 outputs the selected value as a criterion to the comparator 30.

As described above, the semiconductor storage device according to the embodiment can respond to the extended column mode in the first and second embodiments.

A semiconductor storage device, a controller and a memory system according to a fourth embodiment will be described with reference to the drawings.

The embodiment uses batch detection to perform the acquired failure detection operation described in the first embodiment. Hereinafter, only differences from the first embodiment will be described. Moreover, the embodiment responds to an extended column mode in the first and second embodiments. Hereinafter, only differences from the first and second embodiments will be described. Furthermore, the embodiment responds to the case where conflicting defects occur in the first to third embodiments. Hereinafter, only differences from the first to third embodiments will be described.

The concept of conflicting defects will be described.

In the example described with reference to FIG. 6 of the first embodiment, for example, a failure occurs in the latch circuit 22-6 corresponding to the column C6. More specifically, “0” is held in the latch circuit 22-6 even though the column C6 is a normal column. As a result, the total number of bits “0” in the latch circuits 22 becomes greater than the implemented CRD number.

It is assumed that, in FIG. 6, a failure occurs in the latch circuit 22-4 corresponding to the column C4, for example, and the data held in the latch circuit 22-4 is inverted from “0” to “1”. Then, the total number of bits “0” in the latch circuits 22 becomes 4, which is equal to the implemented CRD number. In other words, the failure in the latch circuit 22-6 corresponding to the column C6 looks as if it is offset by the failure in the latch circuit 22 corresponding to the column C4.

Such a case as where failures cannot be correctly detected using only the number of bits “0” in the latch circuit 22 is the “conflicting defect” referred to in the embodiment. The embodiment relates to a method for accurately detecting failures in the latch circuits 22 even when there are conflicting defects.

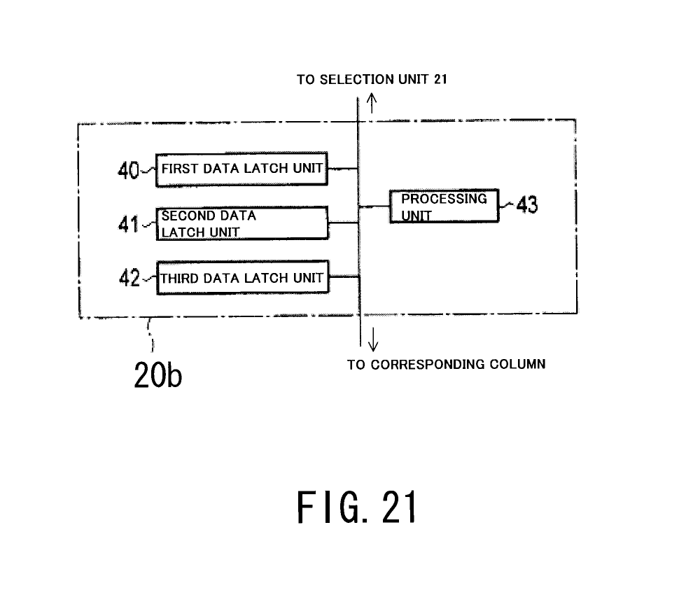

A configuration of a latch circuit will be described with reference to FIG. 21. FIG. 21 is a block diagram showing a configuration of a latch circuit 20b. The latch circuit 20b of the embodiment is obtained by modifying the latch circuit 20 of the first embodiment. In a semiconductor storage device 1c that is an NAND flash memory of the embodiment, latch circuits 20b-0 to 20b-(S−1) are provided.

As shown in FIG. 21, the latch circuit 20b includes a first data latch unit 40, a second data latch unit 41, a third data latch unit 42 and a processing unit 43. The first to third data latch units 40 to 42 hold data, respectively. The processing unit 43 carries out various operations. The first to third data latch units 40 to 42 are connected to a bus so as to be able to transmit and receive data therebetween, and are connected to the processing unit 43 through the bus. Direct data transmission to and reception from the selection unit 21 are performed using the first data latch unit 40, for example.

One column includes eight bit lines BL. Therefore, the first to third data latch units 40 to 42 hold 8-bit data corresponding to the eight bit lines BL, respectively.

FIG. 21 shows the example where each latch circuit 20b includes three data latch units. However, the number of the data latch units may be four or more, and may be two or more in the case of the embodiment.

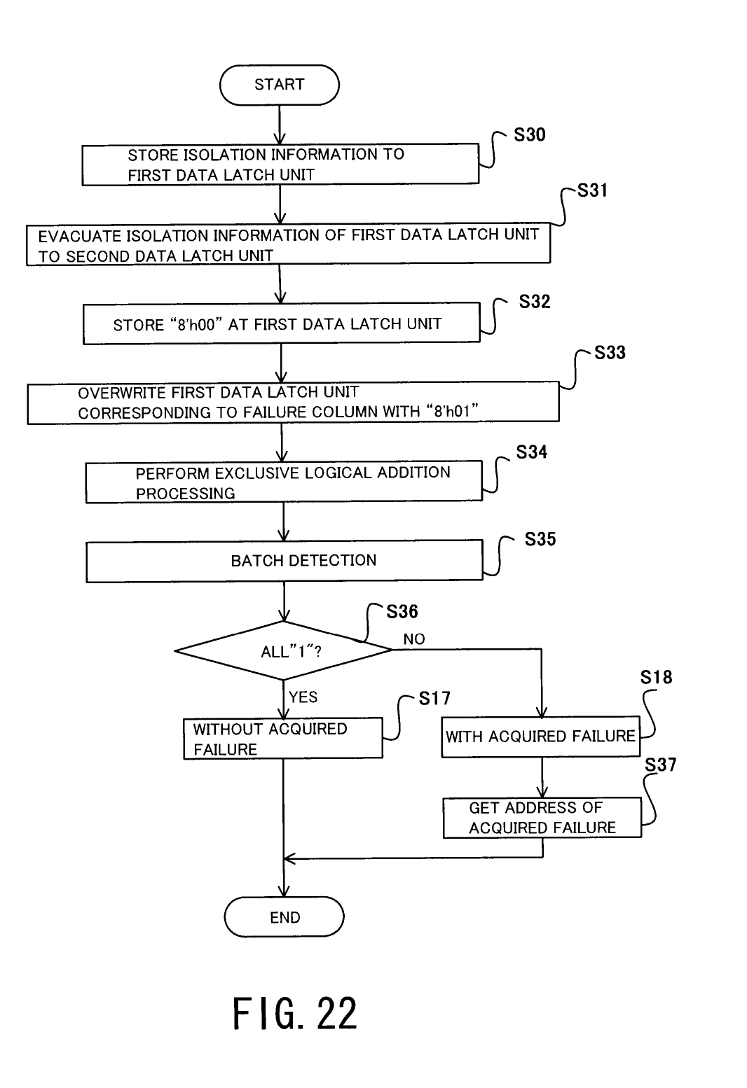

An acquired failure detection operation will be described with reference to FIG. 22. FIG. 22 is a flowchart showing a failure detection method, more particularly showing operations of a column controller 12. The operations shown in FIG. 22 are performed under the control of a controller 14 as in the case of the first embodiment.

As shown in FIG. 22, the controller 14 transfers all isolation data held in first latch circuits 22 to a first data latch unit 40 of a corresponding latch circuit 20d (Step S30).

Next, the controller 14 evacuates the isolation data in the first data latch unit 40 to a second data latch unit 41 (Step S31).

Subsequently, the controller 14 stores data “0” in all bits of the first data latch unit 40 (Step S32). The first data latch unit 40 holds 8-bit data, and thus holds data “00” in hexadecimal notation.

Then, the controller 14 overwrites the first data latch unit 40 corresponding to an innate failure column (and unused redundancy columns) with data “01” (Step S33). More specifically, the least significant bit is inverted from “0” to “1”. It is possible to know, by referring to ROM fuse data, which of the first data latch units 40 corresponds to the innate failure column or the unused redundancy column.

Next, the controller 14 instructs the processing unit 43 to perform an exclusive OR (EXOR) operation on the data in the first and second data latch units 40 and 41 (Step S34).

Subsequently, the controller 14 performs batch detection for the result in Step S34 (Step S36) to detect whether or not all bits in the operation result are “1” for each column.

When all the bits are “1” as a result of the batch detection (“YES” in Step S36), the controller 14 determines that there is no acquired failure (Step S17). On the other hand, when any of the bits is “0” (“NO” in Step S36), the controller 14 determines that there is an acquired failure in the latch circuit 22 corresponding to any of the columns (Step S18). In such a case, the controller 14 identifies an address of the acquired failure by serially reading the operation result (Step S37).

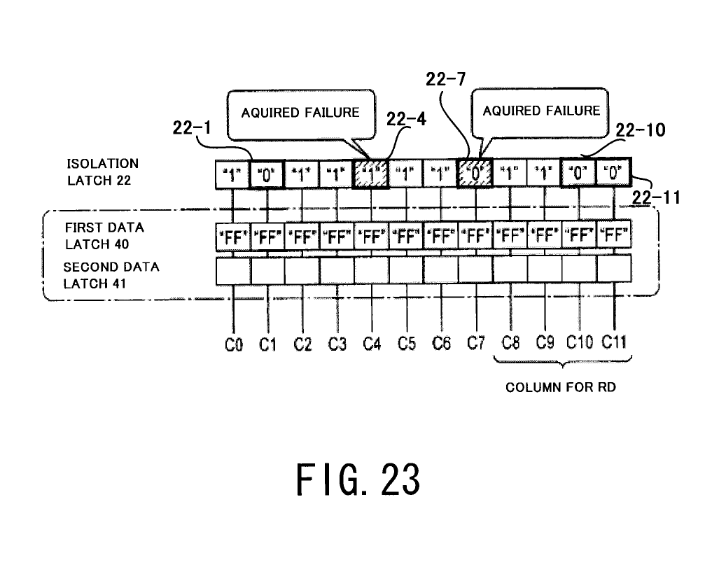

A specific example of the above acquired failure detection operation will be described with reference to FIGS. 23 to 26. FIGS. 23 to 26 are block diagrams showing the operations of the column controller 12.

FIG. 23 shows an example where the column C1 is an innate failure column, and redundancy columns C10 and C11 are not used. An acquired failure has occurred in the latch circuit 22-4, and thus the latch circuit 22-4 holds data “1” even though the circuit should normally hold data “0”. Moreover, an acquired failure has occurred in the latch circuit 22-7, and thus the latch circuit 22-7 holds data “0” even though the circuit should normally hold data “1”. The first data latch unit 40 is reset, and all the bits of the 8-bit data are set to “1” (“8hFF”).

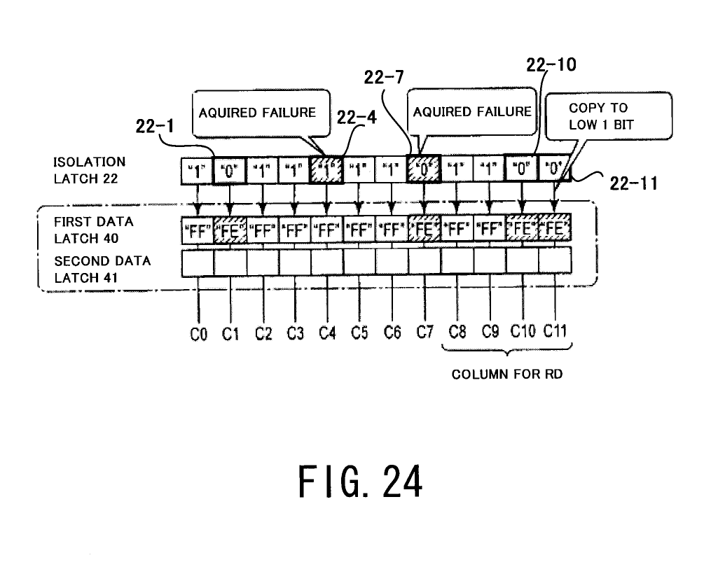

The controller 14 transfers the data in the latch circuit 22 to the first data latch unit 40, as shown in FIG. 24. This operation is the same as that shown in FIG. 18 described above. The 1-bit data in the latch circuit 22 is copied to the least significant bit of the 8-bit data in the first data latch unit 40. As a result, the data held in the first data latch units 40-1, 40-7, 40-10, 40-11 are changed from “FF” to “FE”.

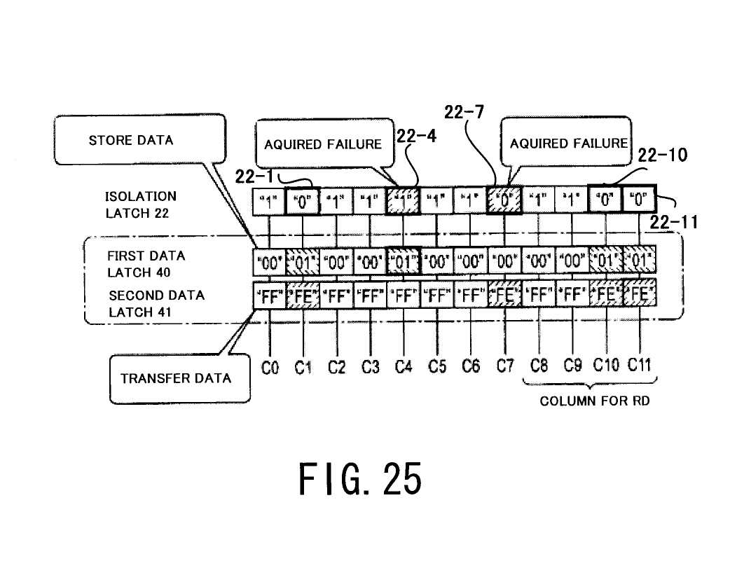

Next, the controller 14 transfers the data in the first data latch units 40 to the second data latch units 41, as shown in FIG. 25. The controller 14 stores “00 (“0000_{—}0000” in binary notation)” in all the first data latch units 40, and rewrites the data in the first data latch unit 40-1, the first data latch unit 40-7, the first data latch unit 40-10 and the first data latch unit 40-11 corresponding to the column C1 with the innate failure, the column C4 with the acquired failure, the unused redundancy column C10 and the unused redundancy column C11, respectively, into “01 (“0000_{—}0001” in binary notation)”.

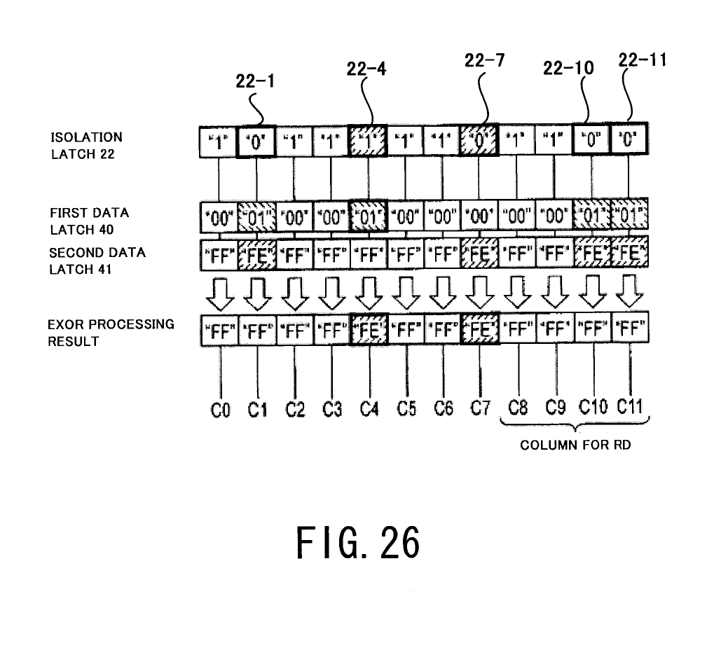

Subsequently, the controller 14 performs exclusive OR operations on the data held in the first data latch unit 40-i and the data held in the second data latch unit 41-i, as shown in FIG. 26. Here, only the operation results on the columns C4 and C7 are “FE (with the least significant bit “0”)”, and the operation results on the other columns are “FF (with all the bits “1”)”. As a result, the controller 14 can recognize that there are acquired failures in the latch circuits 22-4 and 22-7 corresponding to the columns C4 and C7, respectively.

As described above, conflicting defects may occur in the embodiment. A failure with a certain column in a “constant Isolation state” and a failure with another column in a “constant non-Isolation state” may occur at the same time in an acquired manner.

Even in such a case, the semiconductor storage device 1c that is the NAND flash memory of the embodiment can determine whether or not there is an acquired failure in the latch circuits 22.

In the acquired failure detection method according to the embodiment, when the implemented CRD number is 25 and one cycle of the clock CLK is 20 ns, for example, the total time required for the detection operation is about 30 μs, including about 2 us to copy the data from the latch circuit 22 to the first data latch unit 40, about 2 us to transfer the data from the first data latch unit 40 to the second data latch unit 41, about 2 μs to store “8′h00” in all the columns in the first data latch unit 40, about 22 μs to overwrite the first data latch unit 40 corresponding to the failure column (and the unused redundancy columns) with “8′h01”, about 2 μs for the EXOR operation, and several μs for the batch detection.

In comparison with the first to third embodiments, the time required for the detection operation becomes longer, but the failures can be more accurately detected. Therefore, the embodiment is effective in use as a user command sequence and in handing over failure column address data to the controller and the like for data saving processing.

A semiconductor storage device, a controller and a memory system according to a fifth embodiment will be described with reference to the drawings. The embodiment is to determine whether or not there is a failure with a certain column in a “constant Isolation state” and to obtain an address of the failure in the fourth embodiment. Hereinafter, only differences from the fourth embodiment will be described.

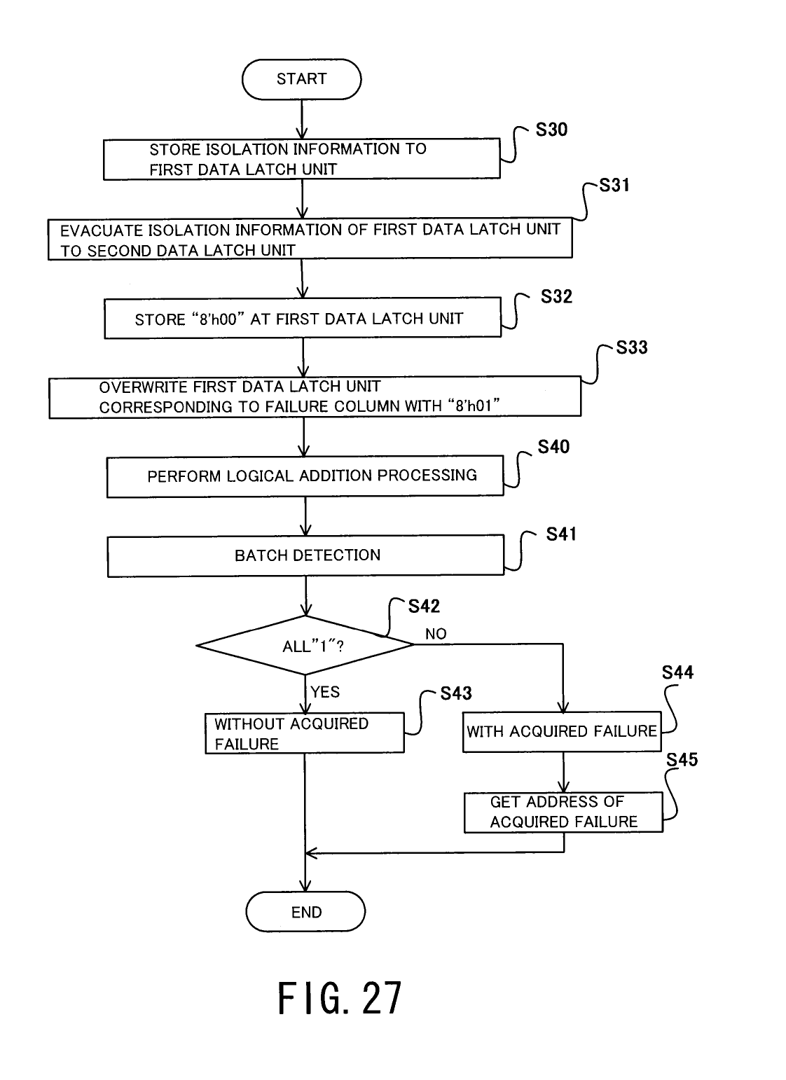

An acquired failure detection operation will be described with reference to FIG. 27. FIG. 27 is a flowchart showing a failure detection method, more particularly showing operations of a column controller 12. The operations shown in FIG. 27 are performed under the control of a controller 14 as in the case of the first embodiment.

In the detection operation, as shown in FIG. 27, the EXOR operation in Step S34 in FIG. 22 described in the fourth embodiment is replaced with an OR operation (Step S40), and subsequent steps (Steps S41 to S45) are changed. The other steps (Steps S30 to S33) are the same as those in the fourth embodiment.

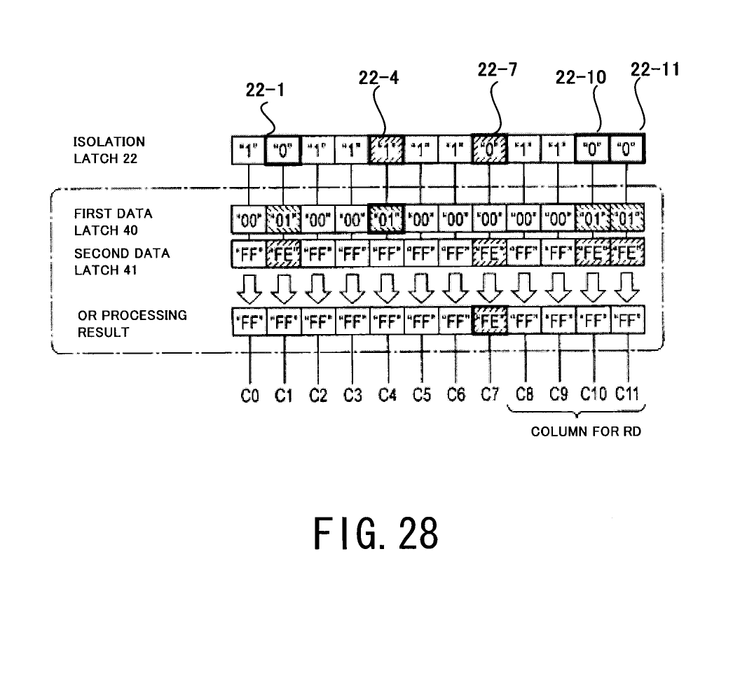

A specific example of the above acquired failure detection operation will be described with reference to FIG. 28. FIG. 28 is a block diagram showing the operations of the column controller 12.

FIG. 28 shows a specific example of the detection operation, and more particularly shows the same case as that described with reference to FIGS. 23 to 26 in the fourth embodiment. In the embodiment, an OR operation is performed as shown in FIG. 28 after the processing shown in FIGS. 23 to 25 as in the case of the fourth embodiment. As a result, the operation result on the column C7 having a failure in a “constant Isolation failure state” (i.e., the column C7 always skipped during normal operation even though the column C7 is a normal column) turns out to be “FE”. Meanwhile, the operation results on the other columns all turn out to be “FF”.

The results show that the column C7 has a failure in the “constant Isolation failure state”.

The semiconductor storage device that is the NAND flash memory of the embodiment can even identify the types of isolation failures. Therefore, failure detection accuracy can be further improved.

A semiconductor storage device, a controller and a memory system according to a sixth embodiment will be described with reference to the drawings. The embodiment is to determine whether or not there is a failure with a certain column in a “constant Isolation state” and to obtain an address of the failure in the fourth embodiment. Hereinafter, only differences from the fourth embodiment will be described.

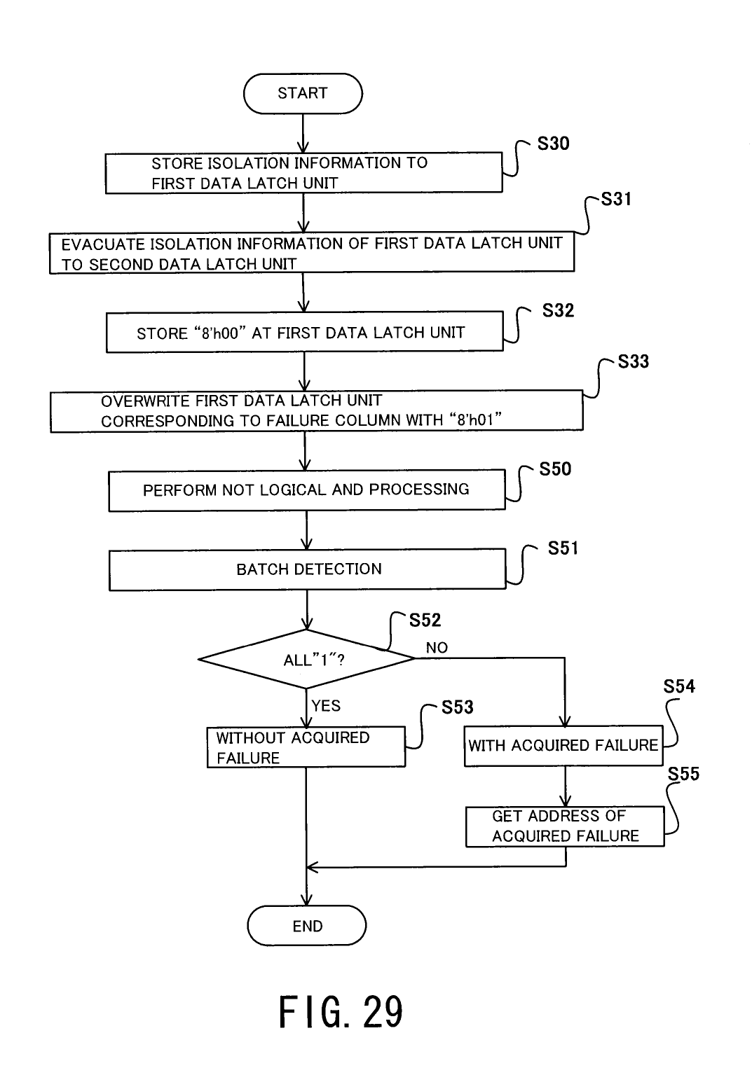

An acquired failure detection operation will be described with reference to FIG. 29. FIG. 29 is a flowchart showing a failure detection method, more particularly showing operations of a column controller 12. The operations shown in FIG. 29 are performed under the control of a controller 14 as in the case of the first embodiment.

In the detection operation, as shown in FIG. 29, the EXOR operation in Step S34 in FIG. 22 described in the fourth embodiment is replaced with a NOT-AND (NAND) operation (Step S50), and subsequent steps (Steps S51 to S55) are changed. The other steps (Steps S30 to S33) are the same as those in the fourth embodiment.

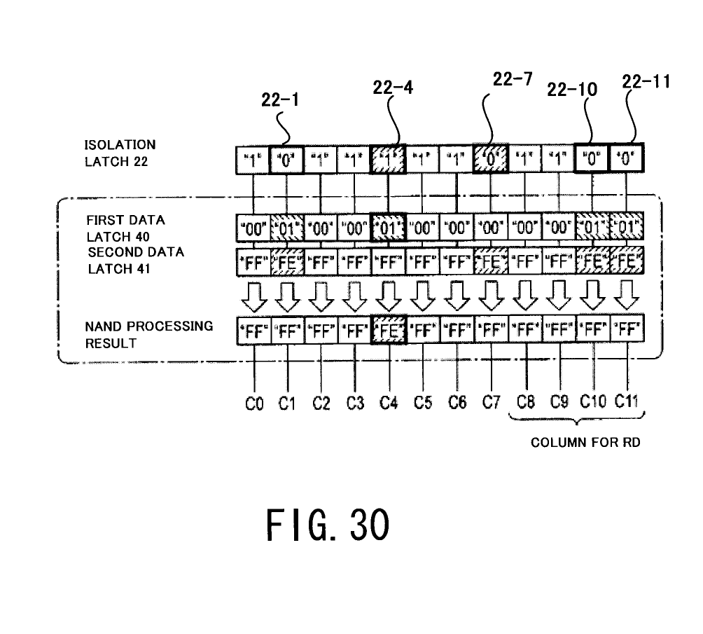

A specific example of the above acquired failure detection operation will be described with reference to FIG. 30. FIG. 30 is a block diagram showing the operations of the column controller 12.

FIG. 30 shows a specific example of the detection operation, and more particularly shows the same case as that described with reference to FIGS. 23 to 26 in the fourth embodiment. In the embodiment, an NAND operation is performed as shown in FIG. 30 after the processing shown in FIGS. 23 to 25 as in the case of the fourth embodiment. As a result, the operation result on the column C4 having a failure in a “constant non-Isolation failure state” (i.e., the column C4 not skipped during normal operation even though the column C4 has a failure) turns out to be “FE”. Meanwhile, the operation results on the other columns all turn out to be “FF”.

The results show that the column C4 has a failure in the “constant non-Isolation failure state”.

As in the case of the fifth embodiment, the semiconductor storage device that is the NAND flash memory of the embodiment can even identify the types of isolation failures. Therefore, failure detection accuracy can be further improved.

A semiconductor storage device, a controller and a memory system according to a seventh embodiment will be described with reference to the drawings. The embodiment relates to combination of the first to sixth embodiments described above. Hereinafter, only differences from the first to sixth embodiments will be described.

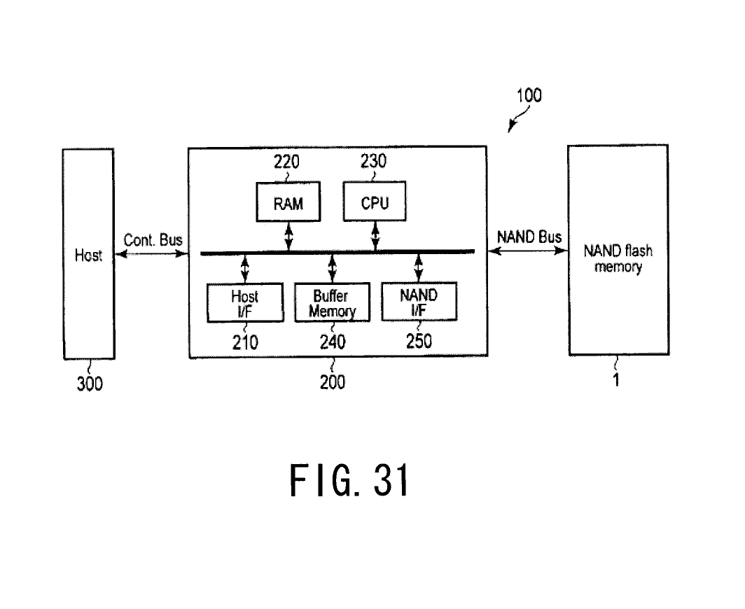

A configuration of the memory system will be described with reference to FIG. 31. FIG. 31 is a block diagram showing the memory system.

As shown in FIG. 31, a memory system 100 includes a semiconductor storage device 1, a controller 200 and a host device 300. Here, the semiconductor storage device 1 that is the NAND flash memory according to the first embodiment is used. However, any one of the semiconductor storage devices according to the second to sixth embodiments may be used instead.

As shown in FIG. 31, the controller 200 instructs the semiconductor storage device 1 that is the NAND flash memory to perform read, write, erase and the like in response to commands from the host device 300. The controller 200 manages a memory space of the semiconductor storage device 1. The controller 200 and the semiconductor storage device 1 may be included in the same semiconductor device, for example. The memory system 100 may be one device, examples of which include a memory card such as an SD™ card, an SSD (solid state drive) and the like. The memory system 100 may have a configuration in which the semiconductor storage device 1 and the controller 200 are included in a personal computer, and is not limited as long as the system is an application with the semiconductor storage device 1.

The controller 200 includes a host interface circuit 210, a RAM 220, a CPU 230, a buffer memory 240 and an NAND interface circuit 250.

The host interface circuit 210 is connected to the host device 300 through a controller bus, and communicates with the host device 300. The host interface circuit 210 transfers commands and data received from the host device 300 to the CPU 230 and the buffer memory 240, respectively. The host interface circuit 210 transfers the data in the buffer memory 240 to the host device 300, in response to a command from the CPU 230.

The NAND interface circuit 250 is connected to the semiconductor storage device 1 through an NAND bus, and communicates with the semiconductor storage device 1. The NAND interface circuit 250 transfers a command received from the CPU 230 to the semiconductor storage device 1 that is the NAND flash memory, and transfers write data in the buffer memory 240 to the semiconductor storage device 1 that is the NAND flash memory during write. Furthermore, during read, the NAND interface circuit 250 transfers the data read from the semiconductor storage device 1 that is the NAND flash memory to the buffer memory 240.

The CPU 230 controls entire operations of the controller 200. For example, upon receipt of a read command from the host device 300, the CPU 230 issues a read command based on the NAND interface. The same goes for write, erase and the like. The CPU 230 executes various processing to manage the semiconductor storage device 1, such as wear leveling. The CPU 230 performs various operations. The CPU 230 executes data encryption, randomizing, data error checking and correcting (ECC), and the like, for example.

The RAM 220 is a semiconductor memory such as a DRAM, for example, and is used as a work area of the CPU 230. The RAM 220 holds firmware to manage the semiconductor storage device 1, various management tables, and the like.

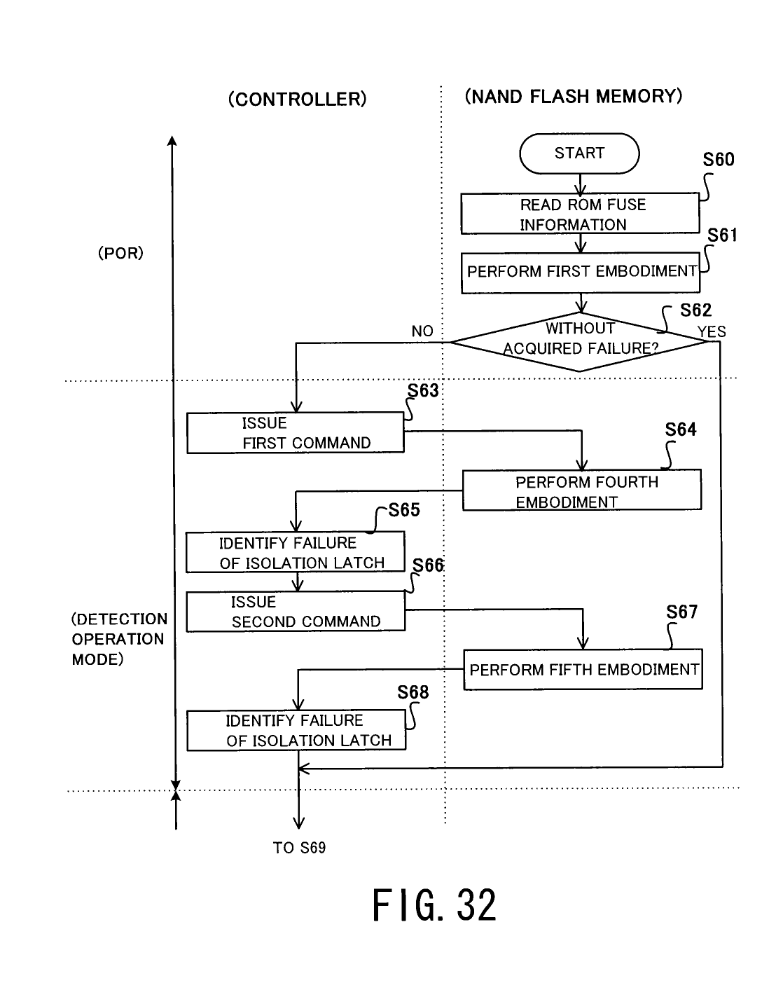

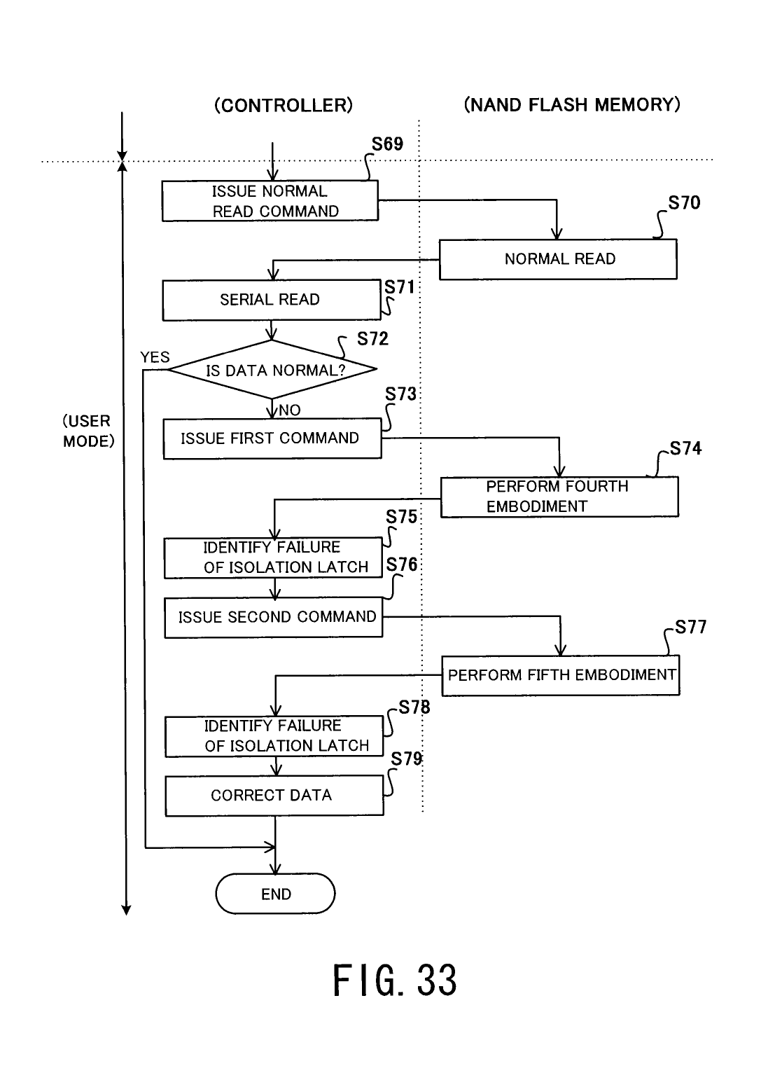

With reference to FIGS. 32 and 33, operations of the memory system 100 will be described while focusing in particular on an acquired failure detection operation. FIGS. 32 and 33 are flowcharts showing the operations of the semiconductor storage device 1 and the controller 200.

As shown in FIG. 32, the semiconductor storage device 1 that is the NAND flash memory executes POR immediately after the power is turned on by the controller 200 or the host device 300. More specifically, the semiconductor storage device 1 reads ROM fuse data from a ROM fuse region in the memory cell array 10 (Step S60). The ROM fuse data includes bad block data indicating a banned block, column redundancy data, trimming data indicating a voltage required for a circuit operation, and the like. The read ROM fuse data is transferred to the controller 200 and stored in an embedded memory 220.

Next, the semiconductor storage device 1 performs the acquired failure detection operation described in the first embodiment, as a part of the POR operation (Step S61). More specifically, the semiconductor storage device 1 executes the processing described with reference to FIG. 5 to check whether or not there is an acquired failure in the latch circuits 22. The semiconductor storage device 1 outputs the detection result to the controller 200. Note that the presence or absence of a failure can be detected at this point, but the type and address of the failure are not yet detected.

As a result of Step S61, the presence or absence of the acquired failure is determined (Step S62). When there is no acquired failure (“NO” in Step S62), the POR operation is terminated, and the memory system 100 is set in a user mode (normal operation mode).

On the other hand, when there is an acquired failure (“YES” in Step S62) as a result of Step S61, the POR operation is terminated, and the controller 200 is set in a detection operation mode. The detection operation mode is an operation mode immediately after the POR operation, and is a mode that is set before the user mode when it is found out that there is an acquired failure after the power is turned on.

In the detection operation mode, the controller 200 issues a first command (Step S63). The first command is a command to detect conflicting defects. In response to the first command, the semiconductor storage device 1 executes the acquired failure detection operation described in the fourth embodiment (Step S64). More specifically, the semiconductor storage device 1 executes the processing described with reference to FIG. 22. As a result, an EXOR operation result is held in the latch circuits 20.

The controller 200 serially reads the EXOR operation result in the latch circuits 20 to identify addresses of all the latch circuits 22 with failures (Step S65).

The controller 200 issues a second command (Step S66). The second command is a command to detect a failure with a column in a constant Isolation state. In response to the second command, the semiconductor storage device 1 executes the acquired failure detection operation described in the fifth embodiment (Step S67). More specifically, the semiconductor storage device 1 executes the processing described with reference to FIG. 27. As a result, an OR operation result is held in the latch circuits 20.

The controller 200 serially reads the OR operation result in the latch circuits 20 to identify an address of the failure with the column in the constant Isolation state in the latch circuits 22 (Step S68). When the address obtained in Step S65 is different from the one obtained in Step S68, the failure turns out to be a failure with a column in a constant non-Isolation state.

As shown in FIG. 33, upon completion of Step S68, the memory system shifts from the detection mode to the user mode. In the normal operation mode, the host device 300 accesses the semiconductor storage device 1. In response to the read command from the host device, for example, the controller 200 issues a normal read command to the semiconductor storage device 1 that is the NAND flash memory (Step S69).

The semiconductor storage device 1 executes normal read in response to the command received (Step S70). More specifically, the semiconductor storage device 1 reads data page by page from the memory cell array 10, and stores the read data in the latch circuits 20.

The controller 200 serially reads the data in the latch circuits 20 (Step S71). Then, it is determined whether or not the serially read data is normal (Step S72). When the serially read data is normal (“YES” in Step S72), the controller 200 finishes the read operation and then outputs the read data to the host device 300. On the other hand, when the data is not normal (“NO” in Step S72), the controller 200 sequentially issues the first command and the second command, as in the case of the POR operation, thereby executing the acquired failure detection operation described in the fourth and fifth embodiments (Steps S73 to S78). Then, based on the result obtained, the data read in Step S71 is corrected (Step S79). Thereafter, the corrected data is outputted to the host device 300.

As described above, in the memory system 100 according to the embodiment, the controller 200 can access the semiconductor storage device 1 that is the NAND flash memory in a state where the presence or absence of a failure in the latch circuits 22, the position of the failure and the type of the failure are identified. Therefore, operation reliability of the memory system 100 can be improved.

Note that FIGS. 32 and 33 show the example where the acquired failure detection operation described in the fourth and fifth embodiments is performed in both of the detection operation mode and the user mode immediately after the POR. However, the acquired failure detection operation may be performed in any one of the detection operation mode and the user mode.

Moreover, in Step S61, the detection operation described in the second embodiment may be performed instead of the detection operation described in the first embodiment. Furthermore, in Steps S67 and S77, the detection operation described in the sixth embodiment may be performed instead of the detection operation described in the fifth embodiment. In this case, the controller 200 can identify the address of the failure with the column in the constant non-Isolation state in Steps S67 and S77. Then, it is found out that the remaining acquired failures are those with the column in the constant Isolation state.

A semiconductor storage device according to a modification will be described with reference to the drawings. A semiconductor storage device 400 according to the modification includes a memory cell array 10a, a plurality of first latch circuits 22, a register 28, and a comparator 30.

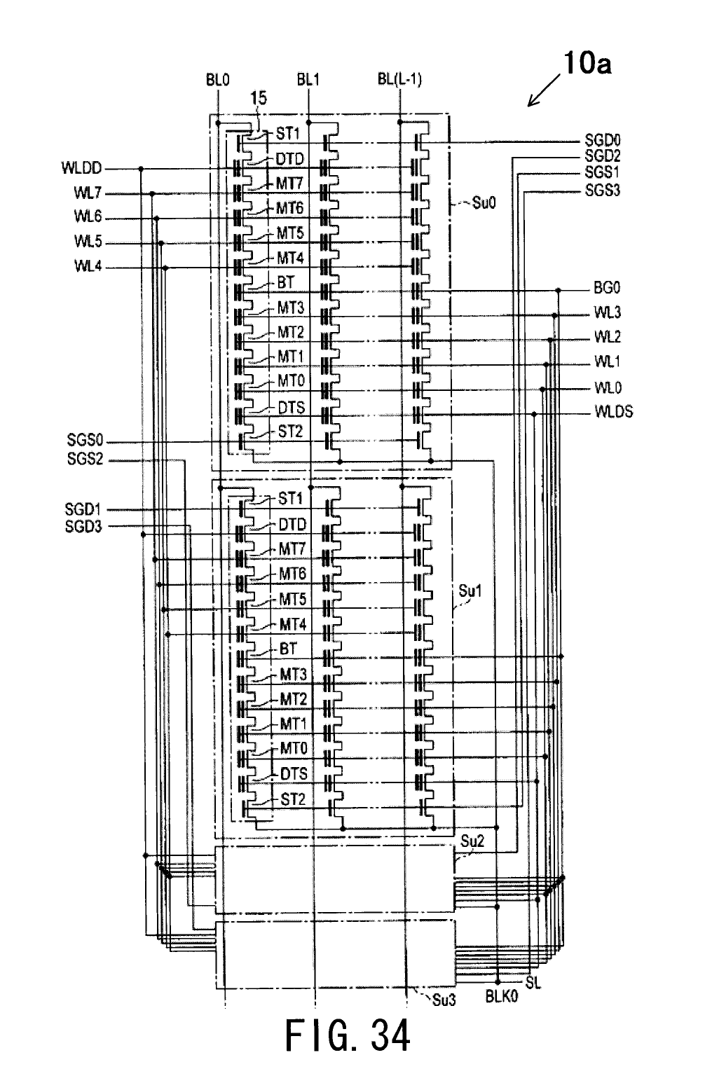

The memory cell array 10a has a plurality of memory cells associated with columns as shown in FIG. 34. The plurality of first latch circuits 22 is provided corresponding to the respective columns, and each hold data on whether or not the corresponding column has a failure. The register 28 holds the number of columns for redundancy. The comparator 30 compares the number of the first latch circuits 22 each holding the data that the column has the failure with a criterion based on the data in the register 28. The semiconductor storage device determines whether or not there is a failure in the first latch circuits 22, based on the result of the comparison by the comparator 30 (Steps S15 to S18 in FIG. 5).

The semiconductor storage device according to the modification can improve the operation reliability. Note that the embodiments are not limited to those described above, but various modifications are possible.

FIGS. 6 to 11 of the first embodiment, for example, shows the case where “0” is set in the latch circuits 22 corresponding to the failure columns or unused redundancy columns. However, “1” may be set instead of “0” or data of two bits or more may be set as long as the value is distinguishable from normal columns or normal redundancy columns in use.

The method for counting the number of the latch circuits 22 having “0” set therein is not limited to those described in the first and second embodiments, but various methods can be used.

Moreover, as to the batch detection in the second embodiment, the description was given of the case where “FF” is held in the latch circuits 20 and the isolation data is copied to the least significant bit of the data, as shown in FIGS. 17 and 18. However, the data held in the latch circuits 20 may be other than “FF”, such as “00”, and the bit to which the isolation data is copied may be a position other than the least significant bit, such as a most significant bit.

Furthermore, in the fourth to sixth embodiments, the description was given of the case where “00” is stored in the first data latch units 40 and the data is overwritten with “01” when the units 40 correspond to failure columns. However, the data set in the first data latch units 40 may be a value other than “00” and “01”, and can be arbitrarily selected. Moreover, the kinds of logical operation are not limited to the EXOR operation, OR operation and NAND operation. In the fourth to sixth embodiments, the description was given of the case where the presence of a failure is determined when the operation result is “FE”. However, the operation result does not always have to be “FE” but may be a value that can be distinguished from an operation result obtained for the column having no failure. For example, it may be determined that there is no failure when all the bits of the operation result are “1 (8hFF)” or “0 (8h00)”, and that there is a failure when the bits of the operation result include both of “1” and “0”.

Note that, although it is possible to detect whether or not there is a failure in the latch circuits 22 in the first and second embodiments, the processing described in the fourth to sixth embodiments is required to detect the address and type of the failure. However, in the first and second embodiments, a quick detection operation is possible and the processing can be simplified. Thus, the first and second embodiments are advantageous in terms of specifications and cost. Moreover, there is a very low probability of simultaneous occurrence of conflicting isolation failures. Thus, the method according to the first and second embodiments achieves sufficient effects.

Furthermore, the memory cell array 10 shown in FIG. 2 may have a configuration as shown in FIG. 34. FIG. 34 is a circuit diagram of a block BLK0. The other blocks BLK1 to BLK3 may have the same configuration. Word lines WL0 to WL3, a dummy word line WLDD adjacent to the word line WL0, a back gate line BG, even-numbered select gate lines SGD0, SGD2, and odd-numbered select gate lines SGS1, SGS3 are extended to one end of the memory cell array 10. On the other hand, word lines WL4 to WL7, a dummy word line WLDS adjacent to the word line WL7, an even-numbered select gate line SGS0, a select gate line SGS2, an odd-numbered select gate line SGD1, and a select gate line SGD3 are extended to the other end of the memory cell array, which is opposite to the one end. The memory cell array may be the above configuration. In the configuration, a row decoder 11 to select the word line WL, for example, may be divided into two row decoders, and the two row decoders may be disposed facing each other on both sides of the memory cell array 10. Then, one of the row decoders may be configured to select the select gate line SGD0, the select gate line SGD2, the select gate line SGS1, the select gate line SGS3, the word lines WL0 to WL3, the dummy word line WLDD and the back gate line BG. Meanwhile, the other row decoder may be configured to select the select gate line SGS0, the select gate line SGS2, the select gate line SGD1, the select gate line SGD3, the word lines WL4 to WL7 and the dummy word line WLDS. The above configuration can reduce congestion of the wiring such as the select gate lines and the word lines in a region between row-system peripheral circuits (row decoders or row drivers) and the memory cell array 10.

Furthermore, the above embodiments are not limited to the NAND flash memory but can be applied to general semiconductor storage devices. The flowcharts described in the above embodiments may be arbitrarily interchanged.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor storage device comprising:
a memory cell array including a plurality of memory cells associated with columns;
a plurality of first latch circuits provided corresponding to the respective columns, each of the plurality of first latch circuits being capable to holding data on whether or not the corresponding column has a failure;
a first register configured to hold the number of columns for redundancy; and
a comparator configured to compare the number of the first latch circuits each holding the data that the column has the failure with a criterion based on the data in the first register, wherein
whether or not there is a failure in the first latch circuits is determined based on the result of the comparison by the comparator.

2. The device according to claim 1, further comprising:
a plurality of second latch circuits provided corresponding to the respective columns, in which a pointer is set; and
a plurality of third latch circuits provided corresponding to the respective columns, each of the plurality of third latch circuits being capable to holding write data or read data for the corresponding column and to be activated when the pointer is set in the second latch circuits under the condition where the corresponding first latch circuit holds the data that the column has no failure, wherein
the pointer is sequentially shifted among the second latch circuits in synchronization with a clock,
the shifting of the pointer in a first mode skips the second latch circuit corresponding to each first latch circuit holding the data that the column has the failure, and
the shifting of the pointer in a second mode skips the second latch circuit corresponding to each first latch circuit holding the data that the column has no failure.

3. The device according to claim 2, further comprising:
a counter synchronized with the clock, wherein
each of a plurality of first selection circuits is electrically connected to the corresponding one of the plurality of second latch circuits on an output side, and every adjacent two of the second latch circuits are electrically connected in series through the corresponding one of the plurality of first selection circuits,
in a process of determining whether or not there is the failure, the second mode is selected and
the comparator compares the criterion with a counter value held by the counter when the pointer is outputted from the last stage of the second latch circuits connected in series.

4. The device according to claim 1, further comprising:
a plurality of third latch circuits provided corresponding to the respective columns, each of the plurality of third latch circuits being capable to holding write data or read data for the corresponding column, wherein
the data in each of the first latch circuits is transferred to the corresponding third latch circuit, and
the number of the first latch circuits each holding the data that the column has the failure is detected by performing batch detection of specific bits in the third latch circuits.

5. The device according to claim 1, wherein
the data that the column has the failure is set in the first latch circuit corresponding to the column for redundancy.

6. The device according to claim 1, further comprising:
a second register configured to hold an isolation setting number in an extended column mode; and
a first selector configured to select an implementation number in the first register in a normal mode, to select the isolation setting number in the second register in the extended column mode, and to output the selected value as the criterion to the comparator.

7. The device according to claim 1, wherein
the memory cell array has a plurality of NAND strings, and
each of the plurality of NAND strings has one end connected to a bit line and the other end connected to a source line, and each of the plurality of NAND strings includes a first select transistor, a plurality of first memory cell transistors, a back gate transistor, a plurality of second memory cell transistors and a second select transistor which are connected in series.

8. The device according to claim 7, wherein
the back gate transistor functions as a current path during data write and data erase.

9. A semiconductor storage device comprising:
a memory cell array including a plurality of memory cell transistors associated with columns;
a plurality of first latch circuits provided corresponding to the respective columns, each of the plurality of first latch circuits being capable to holding data on whether or not the corresponding column has a failure;
second latch circuits provided corresponding to the respective columns; and
third latch circuits provided corresponding to the respective columns, wherein
in a process of detecting a failure in the first latch circuits,
the data in each of the first latch circuits is transferred to the corresponding second latch circuit,
a first value is set in the third latch circuit corresponding to each failure column address obtained from ROM fuse data, and a second value is set in the rest of the third latch circuits, and
the failure in the first latch circuits is detected based on a difference between the columns in result of a logical operation on the data held in the second latch circuit and the data held in the third latch circuit.

10. The device according to claim 9, wherein
the first value is set in the third latch circuit corresponding to the column for redundancy.

11. The device according to claim 9, wherein
each of the second and third latch circuits holds data of a plurality of bits,
the logical operation is any of an exclusive OR (EXOR) operation, a logical OR (OR) operation and a NOT-AND (NAND) operation,
for the column having only “1” or “0” in all the bits in the result of the logical operation, the corresponding first latch circuit is determined as having no failure, and
for the column having both “1” and “0” in the bits in the result of the logical operation, the corresponding first latch circuit is determined as having a failure.

12. The device according to claim 9, wherein
the semiconductor storage device is an NAND flash memory formed by three-dimensional stacking on top of a semiconductor substrate.

13. A memory system comprising an NAND flash memory and a controller, wherein
the NAND flash memory includes a memory cell array, a plurality of first latch circuits, a first register and a comparator,
the memory cell array has a plurality of memory cell transistors associated with columns,
the plurality of first latch circuits are provided corresponding to the respective columns, each of the plurality of first latch circuits holds data on whether or not the corresponding column has a failure,
the first register holds the number of columns for redundancy,
the comparator compares the number of the first latch circuits each holding the data that the column has the failure with a criterion based on the data in the first register,
whether or not there is a failure in the first latch circuits is determined based on the result of the comparison by the comparator,
the controller controls the NAND flash memory, and has a control unit and a memory,
the control unit issues a command to the NAND flash memory, and
the memory holds data on the failure in the first latch circuits.

14. The system according to claim 13, wherein
the NAND flash memory determines whether or not there is a failure in the first latch circuits after reading ROM fuse data immediately after power activation, and
when it is determined that there is the failure, the control unit identifies an address of the failure by issuing a first command, and identifies a type of the failure by issuing a second command.

15. The system according to claim 13, wherein
when data fails to be normally read during read access to the NAND flash memory, the controller identifies an address of the failure by issuing a first command, identifies a type of the failure by issuing a second command, and corrects the data based on the identified address and type of the failure.
